(19) United States
(12) Patent Application Publication
(10) Pub. No.: US 2024/0258576 A1
(43) Pub. Date: Aug. 1, 2024

(54) BATTERY PACK

(71) Applicant: APB Corporation, Tokyo (JP)

(72) Inventors: Hideaki HORIE, Tokyo (JP); Kazuya MINAMI, Kyoto (JP); Kenichi KAWAKITA, Kyoto (JP); Toshiaki YAMAGUCHI, Kyoto (JP); Ryosuke KUSANO, Kyoto (JP); Ryunosuke MAEKAWA, Kyoto (JP)

(21) Appl. No.: 18/564,271

(22) PCT Filed: May 27, 2022
(86) PCT No.: PCT/JP2022/021751

§ 371 Date: Nov. 27, 2023

(30) Foreign Application Priority Data
May 27, 2021 (JP) 2021-089391
May 27, 2021 (JP) 2021-089392
Jun. 4, 2021 (JP) 2021-094345

(51) Int. Cl. H01M 10/0585; H01M 4/02; H01M 4/66; H01M 10/0525; H01M 10/52; H01M 50/207

(52) U.S. Cl. CPC H01M 10/0585; H01M 4/668; H01M 10/0525; H01M 10/52; H01M 50/207; H01M 2004/021

(57) ABSTRACT

A battery pack having two or more cells provided with a lamination unit composed of a single set of a positive electrode resin current collector, a positive electrode active material layer, a separator, a negative electrode active material layer and a negative electrode resin current collector sequentially laminated together, the two or more cells being sealed in an exterior body, in which filler materials are provided in gaps between the cells and/or gaps between the cell and the exterior body.

### TECHNICAL FIELD

The present invention relates to a battery pack.

### BACKGROUND ART

Recently, lithium ion batteries have been often used in a variety of applications as secondary batteries capable of achieving a high energy density and a high output density. An ordinary lithium ion battery is configured by laminating a plurality of cells, and the cell is a substantially flat plate-like lithium secondary cell manufactured by providing each of a positive electrode active material and a negative electrode active material on one surface of a current collector and then laminating the positive electrode active material and the negative electrode active material with a separator interposed between the active material layers.

In such a lithium ion battery obtained by laminating a plurality of cells, the use of a resin current collector as the current collector has been proposed (refer to PTL 1).

In the case of using a resin current collector as the current collector, the resin current collector has a low electron mobility compared with metal current collectors and thus has a low conductivity. Therefore, at the time of laminating the plurality of cells, it is preferable to bring the resin current collectors that are positioned on the upper and lower surfaces of the vertically adjacent cells into close contact with each other, and ingenuity such as deaeration of a container at the time of storing a laminated battery module in the flexible container has been exerted (refer to PTL 2).

### CITATION LIST

### Patent Literature

[PTL 1] Japanese Patent Application Publication No. 2010-62081
[PTL 2] Japanese Patent Application Publication No. 2017-45530

### SUMMARY OF INVENTION

### Technical Problem

However, in spite of such ingenuity, there has been a problem in that, due to the application of external vibrations during the production, transportation or use of batteries and the generation of gas in batteries due to the storage, transportation, use or the like at high temperatures, the positions of vertically adjacent cells deviate from each other and the internal resistance values of battery packs increase.

With the above-described problem in view, an objective of the present invention is to provide a battery pack in which the state of resin current collectors of vertically adjacent cells being in close contact with each other can be maintained.

### Solution to Problem

As a result of intensive studies, the present inventors reached the present invention.

That is, the present invention relates to a battery pack having two or more cells provided with a lamination unit composed of a single set of a positive electrode resin current collector, a positive electrode active material layer, a separator, a negative electrode active material layer and a negative electrode resin current collector sequentially laminated together, the two or more cells being sealed in an exterior body, in which filler materials are provided in gaps between the cells and/or gaps between the cell and the exterior body.

### Advantageous Effects of Invention

According to the present invention, it is possible to provide a battery pack in which the state of resin current collectors of vertically adjacent cells being in close contact with each other can be maintained.

### BRIEF DESCRIPTION OF DRAWINGS

FIG. 1 is a cross-sectional view schematically showing an example of a battery pack of the present invention.

FIG. 2 is a cross-sectional view schematically showing another example of the battery pack of the present invention.

FIG. 3 is a cross-sectional view schematically showing still another example of the battery pack of the present invention.

FIG. 4 is a cross-sectional view schematically showing far still another example of the battery pack of the present invention.

FIG. 5 is a schematic view showing a position where the positional deviation of cells is measured.

### DESCRIPTION OF EMBODIMENTS

Hereinafter, the present invention will be described in detail.

In the present specification, in a case where a lithium ion battery is described, conceptually, the lithium ion battery also includes lithium ion secondary batteries.

A battery pack of the present invention is a battery pack having two or more cells provided with a lamination unit composed of a single set of a positive electrode resin current collector, a positive electrode active material layer, a separator, a negative electrode active material layer and a negative electrode resin current collector sequentially laminated together, the two or more cells being sealed in an exterior body, in which filler materials are provided in gaps between the cells and/or gaps between the cell and the exterior body.

Hereinafter, specific embodiments of the battery pack of the present invention will be described.

Each embodiment to be described below is an example, and it is needless to say that partial substitution or combination of a configuration described in a different embodiment is possible. In second and following embodiments, a common matter with a first embodiment will not be described again, and only a difference will be described. In particular, the same action and effect of the same configuration will not be sequentially described in each embodiment.

### First Embodiment

In a battery pack of the first embodiment, filler materials are provided in gaps between cells and gaps between the cells and an exterior body. In addition, the gaps between the cells include gaps between a frame member and an electrode facing portion, and the filler materials are also provided in those gaps.

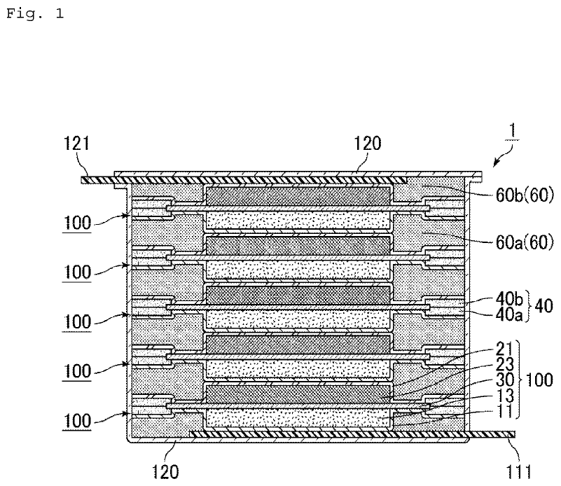

FIG. 1 is a cross-sectional view schematically showing an example of the battery pack of the present invention.

A battery pack 1 shown in FIG. 1 has five cells 100 and is formed by sealing the cells 100 in an exterior body 120.

The cell 100 shown in FIG. 1 has a positive electrode resin current collector 11, a positive electrode active material layer 13, a separator 30, a negative electrode active material layer 23 and a negative electrode resin current collector 21 laminated in this order and has the positive electrode resin current collector 11 and the negative electrode resin current collector 21 in the outermost layers.

The positive electrode resin current collector 11, the positive electrode active material layer 13, the separator 30, the negative electrode active material layer 23 and the negative electrode resin current collector 21 configure a lamination unit (electrode facing portion).

The cell 100 has a frame member 40 disposed in the circumference of the lamination unit between the positive electrode resin current collector 11 and the negative electrode resin current collector 21.

The frame member 40 holds the separator 30 between a positive frame member 40a and a negative frame member 40b and thereby fixes the peripheral portion of the separator 30.

A negative electrode-side high-voltage tab 121 is connected to the negative electrode resin current collector 21 of the cell 100, which is positioned uppermost, and the high-voltage tab 121 is drawn out toward the outside of the exterior body 120.

Similarly, a positive electrode-side high-voltage tab 111 is connected to the positive electrode resin current collector 11 of the cell 100, which is positioned lowermost, and the high-voltage tab 111 is drawn out toward the outside of the exterior body 120.

Between the plurality of cells 100, there are gaps in the outer circumferential portions of the cells 100, and filler materials 60 (filler materials 60a) are provided in the gaps between the cells 100.

In addition, a filler material 60 (filler material 60b) is provided in a gap between the cell 100 that is positioned uppermost among the cells 100 and the exterior body 120. Similarly, a filler material 60 (filler material 60b) is provided in a gap between the cell 100 that is positioned lowermost among the cells 100 and the exterior body 120.

The gaps between the cells in the present specification mean gaps between the cells in portions where the positive electrode active material layer and the negative electrode active material layer are not laminated together in the outer circumferential portions of the cells and do not mean gaps between the cells in portions configuring the lamination units where the positive electrode active material layer and the negative electrode active material layer are laminated together (electrode facing portions). Filler materials provided between the gaps between the cells in the electrode facing portions cause an increase in electrical resistance, which is not preferable.

When the battery pack includes the filler materials in the gaps between the cells and/or the gaps between the cell and the exterior body, it is possible to maintain a state of the cells vertically adjacent to each other in the battery pack being in close contact with each other in a case where external vibrations are applied during the production, transportation or use of the battery.

Therefore, the positional deviation of the cells is unlikely to occur, and the generation of an internal resistance value of the battery pack due to external vibrations is prevented.

In addition, the breakage of the resin current collectors due to vibrations is prevented.

The filler material preferably contains gas adsorption particles.

When the filler material contains gas adsorption particles, it is possible to suitably adsorb gases that are generated in association with the charge and discharge of lithium ion batteries.

There are cases where gas is generated in lithium ion batteries during the storage, transportation, use or the like at high temperatures, but the influence of the gas generated can be suppressed by adsorption of the gas with the gas adsorption particles.

As a result, the positional deviation of the vertically adjacent cells is prevented, and an increase in the internal resistance values of the battery packs is prevented.

In addition, the filler material may contain other components together with the gas adsorption particles and may be a mixture of a resin material and gas adsorption particles. The kind of the resin material is not particularly limited, and acrylic resins, epoxy-based resins, polyolefin-based resins, polyurethane-based resins, polyvinylidene fluoride resins and the like can be used. The resin material may be a material that is commercially available as a sealing material or an adhesive, and, for example, LOCTITE (registered trademark) and the like can be used.

The filler material is preferably a material for which the tensile shear strength between a filler material and a PET plate is 0.05 N/mm² or higher. The tensile shear strength between a filler material and a PET plate can be measured according to JIS K 6850.

A filler material from which the tensile shear strength can be measured is an adhesive material capable of the adhesion of PET plates, and the tensile shear strength is measured after a PET plate is made to adhere using the filler material as an adhesive. In a case where the filler material is an adhesive material containing gas adsorption particles, the tensile shear strength is measured using the filler material as an adhesive in a state of containing the gas adsorption particles.

When the tensile shear strength is 0.05 N/mm² or higher, the positional deviation of the cells is more unlikely to occur. In addition, the tensile shear strength may be 25 N/mm² or lower.

The gas adsorption particles are preferably one or more selected from the group consisting of activated carbon, zeolite, silica and alumina. In addition, the gas adsorption particles are preferably porous.

The volume-average particle diameter of the gas adsorption particles is preferably 0.04 to 50 μm and more preferably 0.04 to 8 μm.

Gas adsorption particles having a volume-average particle diameter of smaller than 0.04 μm are difficult to produce.

When the volume-average particle diameter of the gas adsorption particles exceeds 50 μm, the particle diameters of the gas adsorption particles are large relative to the sizes of the gaps between the cells to be assumed, and it becomes difficult to fill the gaps between the cells with the gas adsorption particles, and thus there are cases where the internal resistance values of the battery packs increase.

The volume-average particle diameter of particles (gas adsorption particles and the like) in the present specification means the particle diameter at a cumulative value of 50% (Dv50) in a particle size distribution obtained by a microtrac method (laser diffraction and scattering method). The microtrac method is a method by which particle size distributions are obtained using scattered light that is obtained by irradiating particles with laser light. MICROTRAC manufactured by Nikkiso Co., Ltd. or the like can be used for the measurement of the volume-average particle diameter of particles.

The weight proportion of the gas adsorption particles is preferably 30 to 50 weight % based on the weight of the filler material.

This weight proportion is more preferably 40 to 50 weight %.

When the weight proportion of the gas adsorption particles is within this range, the balance between the strength of the filler material and the gas adsorption performance is excellent, and it is thus possible to suppress the positional deviation of the cells and to decrease the internal resistance values of the battery packs.

The specific surface area of the gas adsorption particles is preferably 100 to 2000 m²/g and more preferably 300 to 900 m²/g.

When the specific surface area of the gas adsorption particles is within the above-described range, it is possible to suitably adsorb gases that are generated in association with the charge and discharge of lithium ion batteries.

In the present specification, the specific surface area of the gas adsorption particles is a value measured as a BET specific surface area according to “Determination of the specific surface area of powders (solids) by gas adsorption-BET method of JIS Z 8830”.

Hereinafter, a preferable aspect of each configuration element configuring the cell will be described.

First, each element forming the lamination unit of the cell will be described.

In the cell, it is preferable that the positive electrode active material layer and/or the negative electrode active material layer contain coated electrode active material particles in which at least a part of the surface of each electrode active material particle is coated with a coating layer and are unbound bodies of the coated electrode active material particles.

When the positive electrode active material layer and/or the negative electrode active material layer are unbound bodies of the coated electrode active material particles, since the positive electrode active material layer and/or the negative electrode active material layer are flexible at the time of laminating and pressurizing the cells, the coated electrode active material particles are capable of flowing depending on the pressure during the pressurization. Therefore, unevenness is not formed on the surfaces of the cells. When unevenness is not formed on the surfaces of the cells, it is possible to suppress the wear of the resin current collectors.

In the description of the positive electrode active material layer and the negative electrode active material layer, the above-described aspect will be described.

The positive electrode active material layer contains positive electrode active material particles.

Examples of the positive electrode active material particles include composite oxides of lithium and a transition metal {composite oxides containing one transition metal (LiCoO₂, LiNiO₂, LiAlMnO₄, LiMnO₂, LiMn₂O₄ and the like), composite oxides containing two transition metal elements (for example, LifeMnO₄, LiNi₁₋ₓCoₓO₂, LiMn_{1-y}CO_{y}O₂, LiNi_{1/3}CO_{1/3}Al_{1/3}O₂ and LiNi_{0.8}Co_{0.15}Al_{0.05}O₂), composite oxides containing three or more transition metals [for example, LiMₐM′_{b}M″_{c}O₂ (M, M′ and M″ are each a different transition metal element and a+b+c=1 is satisfied; for example, LiNi_{1/3}Mn_{1/3}CO_{1/3}O₂) and the like] and the like}, lithium-containing transition metal phosphates (for example, LiFePO₄, LiCoPO₄, LiMnPO₄ and LiNiPO₄), transition metal oxides (for example, MnO₂ and V₂O₅), transition metal sulfides (for example, MoS₂ and TiS₂), conductive polymers (for example, polyaniline, polypyrrole, polythiophene, polyacetylene, poly-p-phenylene and polyvinyl carbazole) and the like, and two or more thereof may be jointly used.

The lithium-containing transition metal phosphates may be lithium-containing transition metal phosphates in which some of the transition metal sites are substituted with a different transition metal.

The positive electrode active material particles are preferably coated positive electrode active material particles coated with coating layers.

The coating layer is a layer composed of an auxiliary conductive agent and a polymer compound.

When the positive electrode active material particles are coated with the coating layers, a volume change of the electrode is alleviated, and the expansion of the electrode can be suppressed.

Examples of the auxiliary conductive agent include metal-based auxiliary conductive agents [aluminum, stainless steel (SUS), silver, gold, copper, titanium and the like], carbon-based auxiliary conductive agents [graphite, carbon black (acetylene black, Ketjen black, furnace black, channel black, thermal lamp black and the like) and the like], mixtures thereof and the like.

These auxiliary conductive agents may be used singly or two or more thereof may be jointly used. In addition, these auxiliary conductive agents may be used as an alloy or metal oxide thereof.

Among them, from the viewpoint of the electrical stability, aluminum, stainless steel, silver, gold, copper, titanium, carbon-based auxiliary conductive agents and mixtures thereof are more preferable, silver, gold, aluminum, stainless steel and carbon-based auxiliary conductive agents are still more preferable and carbon-based auxiliary conductive agents are particularly preferable.

In addition, these auxiliary conductive agents may be particulate ceramic materials or resin materials having a surround coated with a conductive material [preferably a metal auxiliary conductive agent among the above-described auxiliary conductive agents] by plating or the like.

The shape (form) of the auxiliary conductive agent is not limited to the particle form, may be a form other than the particle form and may be a form that has been put into practical use as a so-called filler-based auxiliary conductive agent such as a carbon nanofiber or a carbon nanotube.

The ratio between the polymer compound and the auxiliary conductive agent is not particularly limited, but the weight ratio between the polymer compound (the weight of the resin solid content) and the auxiliary conductive agent is preferably 1:0.01 to 1:50 and more preferably 1:0.2 to 1:3.0.

As the polymer compound, polymer compounds described as a resin for coating a non-aqueous secondary battery active material in Japanese Patent Application Publication No. 2017-054703 can be suitably used.

In addition, the positive electrode active material layer may contain an auxiliary conductive agent other than the auxiliary conductive agent that is contained in the coated positive electrode active material particles.

As the auxiliary conductive agent, the same auxiliary conductive agent as the above-described auxiliary conductive agent that is contained in the coated positive electrode active material particles can be suitably used.

The coating layer may further contain ceramic particles.

Examples of the ceramic particles include metal carbide particles, metal oxide particles, glass ceramic particles and the like.

Examples of the metal carbide particles include silicon carbide (Sic), tungsten carbide (WC), molybdenum carbide (MO₂C), titanium carbide (TiC), tantalum carbide (TaC), niobium carbide (NbC), vanadium carbide (VC), zirconium carbide (ZrC) and the like.

Examples of the metal oxide particles include zinc oxide (ZnO), aluminum oxide (Al₂O₃), silicon dioxide (SiO₂), tin oxide (SnO₂), titania (TiO₂), zirconia (ZrO₂), indium oxide (In₂O₃), Li₂B₄O₇, Li₄Ti₅O₁₂, Li₂Ti₂O₅, LiTaO₃, LiNDO₃, LiAlO₂, Li₂ZrO₃, Li₂WO₄, Li₂TiO₃, Li₃PO₄, Li₂MoO₄, Li₂BO₃, LiBO₂, Li₂CO₃, Li₂SiO₃, perovskite-type oxide particles represented by ABO₃ (where A is at least one selected from the group consisting of Ca, Sr, Ba, La, Pr and Y and B is at least one selected from the group consisting of Ni, Ti, V, Cr, Mn, Fe, Co, Mo, Ru, Rh, Pd and Re) and the like.

From the viewpoint of suitably suppressing a side reaction occurring between an electrolytic solution and the coated positive electrode active material particles, zinc oxide (ZnO), aluminum oxide (Al₂O₃), silicon dioxide (SiO₂) and lithium tetraborate (Li₂B₄O₇) are preferable as the metal oxide particles.

The ceramic particles are preferably glass ceramic particles from the viewpoint of suitably suppressing a side reaction occurring between an electrolytic solution and the coated positive electrode active material particles.

One kind of these glass ceramic particles may be used singly or two or more kinds thereof may be jointly used.

The glass ceramic particles are preferably a lithium-containing phosphate compound having a rhombohedral system, and the chemical formula thereof is represented by LiₓM″₂P₃O₁₂ (X=1 to 1.7).

Here, M″ is one or more elements selected from Zr, Ti, Fe, Mn, Co, Cr, Ca, Mg, Sr, Y, Sc, Sn, La, Ge, Nb and Al. In addition, some of P may be substituted with Si or B, and some of O may be substituted with F, Cl or the like. For example, Li_{1.15}Ti_{1.85}Al_{0.15}Si_{0.05}P_{2.95}O₁₂, Li_{1.2}Ti_{1.8}Al_{0.1}Ge_{0.1}Si_{0.05}P_{2.95}O₁₂ and the like can be used.

In addition, materials having a different composition may be mixed or composited and the surface may be coated with a glass electrolyte or the like. Alternatively, it is preferable to use glass ceramic particles from which a crystal phase of a lithium-containing phosphate oxide having a NASICON-type structure is precipitated by a heat treatment.

Examples of the glass electrolyte include glass electrolytes described in Japanese Patent Application Publication No. 2019-96478.

Here, the proportion of Li₂O blended in the glass ceramic particles is preferably 8 mass % or less in terms of oxide.

A solid electrolyte containing Li, La, Mg, Ca, Fe, Co, Cr, Mn, Ti, Zr, Sn, Y, Sc, P, Si, O, In, Nb and F, having a LISICON-type crystal structure, a perovskite-type crystal structure, a β-Fe₂(SO₄)₃-type crystal structure and a Li₃In₂ (PO₄)₃-type crystal structure and having a Li ion conductivity of 1×10⁻⁵ S/cm or higher at room temperature may be used even when the solid electrolyte does not have a NASICON-type structure.

One kind of the above-described glass ceramic particles may be used or two or more kinds thereof may be jointly used.

The volume-average particle diameter of the ceramic particles is preferably 1 to 1000 nm, more preferably 1 to 500 nm and still more preferably 1 to 150 nm from the viewpoint of the energy density and the viewpoint of the electrical resistance value.

The weight proportion of the ceramic particles is preferably 0.5 to 5.0 weight % based on the weight of the coated positive electrode active material particles.

When the ceramic particles are contained to the above-described extent, it is possible to suitably suppress a side reaction occurring between an electrolytic solution and the coated positive electrode active material particles.

The weight proportion of the ceramic particles is more preferably 2.0 to 4.0 weight % based on the weight of the coated positive electrode active material particles.

The positive electrode active material layer is preferably an unbound body containing a positive electrode active material but not containing a binder that binds the positive electrode active material molecules.

Here, the unbound body means that the positive electrode active material molecules are not bound with each other, and binding means that the positive electrode active material molecules are irreversibly fixed to each other.

The positive electrode active material layer may contain a pressure-sensitive adhesive resin.

As the pressure-sensitive adhesive resin, for example, a pressure-sensitive adhesive resin having a glass transition temperature to room temperature or lower by mixing a small amount of an organic solvent with the resin for coating a non-aqueous secondary battery active material in Japanese Patent Application Publication No. 2017-054703, a pressure-sensitive adhesive resin described as a pressure-sensitive adhesive in Japanese Patent Application Publication No. H10-255805 and the like can be suitably used.

The pressure-sensitive adhesive resin means a resin having pressure-sensitive adhesiveness (a property of adhering when a slight pressure is applied thereto without using water, a solvent, heat or the like) without being solidified even when being dried by volatilizing a solvent component. Incidentally, a solution drying-type electrode binder that is used as a binder means a binder that makes active material molecules strongly adhere and be fixed to each other by being dried and solidified by volatilizing a solvent component.

Therefore, the solution drying-type electrode binder (binder) and the pressure-sensitive adhesive resin are different materials.

The thickness of the positive electrode active material layer is not particularly limited, but is preferably 100 to 700 μm and more preferably 300 to 600 μm from the viewpoint of battery performance.

The negative electrode active material layer contains negative electrode active material particles.

As the negative electrode active material particles, a well-known negative electrode active material for a lithium ion battery can be used, and examples thereof include carbon-based materials [graphite, non-graphitizable carbon, amorphous carbon, fired resin bodies (for example, a body obtained by firing and carbonizing a phenol resin, a furan resin or the like and the like), cokes (for example, pitch coke, needle coke, petroleum coke and the like), carbon fibers and the like], silicon-based materials [silicon, silicon oxide (SiOₓ), silicon-carbon composites (carbon particles having surfaces coated with silicon and/or silicon carbide, silicon particles or silicon oxide particles having surfaces coated with carbon and/or silicon carbide, silicon carbide and the like), silicon alloys (a silicon-aluminum alloy, a silicon-lithium alloy, a silicon-nickel alloy, a silicon-iron alloy, a silicon-titanium alloy, a silicon-manganese alloy, a silicon-copper alloy, a silicon-tin alloy and the like) and the like], conductive polymers (for example, polyacetylene, polypyrrole and the like), metals (tin, aluminum, zirconium, titanium and the like), metal oxides (titanium oxide, lithium/titanium oxide and the like), metal alloys (for example, a lithium-tin alloy, a lithium-aluminum alloy, a lithium-aluminum-manganese alloy and the like), mixtures of the above-described negative electrode active material and a carbon-based material and the like.

In addition, the negative electrode active material particles may be coated negative electrode active material particles coated with the same coating layers as in the above-described coated positive electrode active material particles.

As an auxiliary conductive agent, a polymer compound and ceramic particles that configure the coating layer, the same auxiliary conductive agent, polymer compound and ceramic particles as in the above-described coated positive electrode active material particles can be suitably used.

In addition, the negative electrode active material layer may contain an auxiliary conductive agent other than the auxiliary conductive agent that is contained in the coated negative electrode active material particles. As the auxiliary conductive agent, the same auxiliary conductive agent as the above-described auxiliary conductive agent that is contained in the coated positive electrode active material particles can be suitably used.

The negative electrode active material layer is, similar to the positive electrode active material layer, preferably an unbound body not containing a binder that binds the negative electrode active material molecules. In addition, similar to the positive electrode active material layer, the negative electrode active material layer may contain a pressure-sensitive adhesive resin.

The thickness of the negative electrode active material layer is not particularly limited, but is preferably 100 to 900 μm, also preferably 300 to 800 μm and also preferably 500 to 700 μm from the viewpoint of battery performance.

The thickness of the positive electrode active material layer and the thickness of the negative electrode active material layer may be the same as or different from each other, and the thickness of the negative electrode active material layer may be larger than the thickness of the positive electrode active material layer.

In addition, the positive electrode active material layer and/or the negative electrode active material layer may be electrode active material layers containing coated electrode active material particles for a lithium ion battery in which at least a part of the surface of each electrode active material particle is coated with a coating layer, the coating layer may contain gas adsorption particles, a polymer compound and an auxiliary conductive agent, and the volume-average particle diameter of the gas adsorption particles may be 0.04 to 20 μm.

When gas adsorption particles having the above-described sizes are contained in the coating layer that coats the electrode active material particles, the gas adsorption particles are capable of adsorbing gases even when gases are generated in association with charge and discharge.

Therefore, it is possible to suppress an increase in the internal resistance values of lithium ion batteries.

This is considered to be because the gas adsorption particles are contained in the coating layers, whereby the gas adsorption particles are positioned at places to which gas is likely to be adsorbed.

In a case where the coating layer contains the gas adsorption particles, the weight proportion of the gas adsorption particles in the coating layer is preferably 0.3 to 6 weight % based on the weight of the coated electrode active material particle.

In addition, the volume-average particle diameter of the coated electrode active material particles for a lithium ion battery is preferably 5 to 40 μm.

In addition, the electrode active material layers each contain the coated electrode active material particles for a lithium ion battery and an electrolytic solution containing an electrolyte and a solvent and are each preferably an unbound body of the coated electrode active material particles for a lithium ion battery.

In addition, the gas adsorption particles that are contained in the coating layer are preferably one or more selected from the group consisting of activated carbon, zeolite, silica and alumina.

The positive electrode resin current collector and the negative electrode resin current collector are resin current collectors made of a conductive polymer material.

The thicknesses of the positive electrode resin current collector and the negative electrode resin current collector are not particularly limited, but are preferably 50 to 500 μm for each of the positive electrode resin current collector and the negative electrode resin current collector.

As the conductive polymer material that configures the resin current collectors, a conductive polymer or a resin to which a conductive agent is added as necessary can be used.

As the conductive agent that configure the conductive polymer material, the same auxiliary conductive agent as the above-described auxiliary conductive agent that is contained in the coated positive electrode active material particles can be suitably used.

Examples of the resin that configures the conductive polymer material include polyethylene (PE), polypropylene (PP), polymethylpentene (PMP), polycycloolefin (PCO), polyethylene terephthalate (PET), polyethernitrile (PEN), polytetrafluoroethylene (PTFE), styrene butadiene rubber (SBR), polyacrylonitrile (PAN), polymethyl acrylate (PMA), polymethyl methacrylate (PMMA), polyvinylidene fluoride (PVdF), epoxy resins, silicone resins, mixtures thereof and the like.

From the viewpoint of the electrical stability, polyethylene (PE), polypropylene (PP), polymethylpentene (PMP) and polycycloolefin (PCO) are preferable, and polyethylene (PE), polypropylene (PP) and polymethylpentene (PMP) are more preferable.

In addition, the positive electrode resin current collector and/or the negative electrode resin current collector may be resin current collectors made of a resin composition containing a polyolefin resin, a conductive filler and gas adsorption particles, and the weight proportion of the gas adsorption particles may be 5 to 20 weight % based on the weight of the resin current collector.

When the resin current collectors contain gas adsorption particles, it is possible to adsorb gases that are generated in association with the charge and discharge of lithium ion batteries with the gas adsorption particles that are contained in the current collectors.

Therefore, it is possible to suppress an increase in the internal resistance values of lithium ion batteries attributed to the gas.

In a case where the resin current collectors contain the gas adsorption particles, the volume-average particle diameter of the gas adsorption particles that are contained in the resin current collectors is preferably 0.04 to 20 μm.

In addition, the weight proportion of the conductive filler that is contained in the resin current collector is preferably 15 to 20 weight % based on the weight of the resin current collector.

In addition, the film thicknesses of the resin current collectors are preferably 30 to 60 μm.

In addition, the gas adsorption particles that are contained in the resin current collectors are preferably one or more selected from the group consisting of activated carbon, zeolite, silica and alumina.

The gas adsorption particles may be contained in all of the filler material, the coating layers that coat the electrode active materials and the resin current collectors. The gas adsorption particles may be contained in two of the filler material, the coating layers and the resin current collectors, and the gas adsorption particles may not be contained in the remaining one. In addition, the kind of the gas adsorption particles that are contained in each place may be the same as or different from each other.

Examples of the separator include well-known separators for a lithium ion battery such as polyethylene or polypropylene porous films, laminate films of a porous polyethylene film and porous polypropylene, non-woven fabrics made of a synthetic fiber (a polyester fiber, an aramid fiber or the like), a glass fiber or the like and the above-described separators containing ceramic fine particles of silica, alumina, titania or the like attached to the surfaces.

The positive electrode active material layer and the negative electrode active material layer each contain an electrolytic solution.

As the electrolytic solution, it is possible to use well-known electrolytic solutions containing an electrolyte and a non-aqueous solvent that are used to produce well-known lithium ion batteries.

As the electrolyte, electrolytes that are used in well-known electrolytic solutions can be used, and examples thereof include lithium salts of an inorganic anion such as LiPF₆, LiBF₄, LiSbF₆, LiAsF₆, LiClO₄ and LiN (FSO₂)₂ and lithium salts of an organic anion such as LIN (CF₃SO₂)₂, LIN (C₂F₅SO₂)₂ and LiC(CF₃SO₂)₃. Among these, LiN (FSO₂)₂ is preferable from the viewpoint of the battery output and the charge and discharge cycle characteristics.

As the solvent, non-aqueous solvents that are used in well-known electrolytic solutions can be used, and it is possible to use, for example, lactone compounds, cyclic or chain carbonates, chain carboxylates, cyclic or chain ethers, phosphates, nitrile compounds, amide compounds, sulfones, sulfolane and mixtures thereof.

Next, the frame member will be described.

A material that configures the frame member is not particularly limited as long as the material is durable with respect to electrolytic solutions, but is preferably a polymer material.

The polymer material may be a thermosetting polymer material. Specific examples thereof include epoxy-based resins, polyolefin-based resins, polyester-based resins, polyurethane-based resins, polyvinylidene fluoride resins and the like, and epoxy-based resins are preferable due to high durability and easy handling.

The polymer material may be a thermoplastic polymer material. Specifically, the polymer material is preferably composed of one or more materials selected from an ethylene-vinyl acetate copolymer, a maleic anhydride-modified polyethylene and an acid-modified polypropylene.

The frame member may be made up of a positive frame member and a negative frame member. The positive frame member and the negative frame member may be each a different material or the same material. It is preferable that the frame member is made up of a positive frame member and a negative frame member and holds and fixes the peripheral portion of the separator with the positive frame member and the negative frame member.

In the battery pack of the present invention, two or more cells are sealed in the exterior body. The material of the exterior body is not particularly limited as long as the exterior body is capable of sealing two or more cells but is preferably so flexible a material and a form that, at the time of sealing and pressurizing two or more cells, the shape of the material changes along the shape of the laminate of the cells.

As a flexible exterior body, preferably, an aluminum laminate film having an insulation-treated inner surface can be used. The thickness of the exterior body is preferably 100 to 300 μm from the viewpoint of having appropriate flexibility and strength.

In addition, as an inflexible exterior body, a metal can having an insulation-treated inner surface can also be used.

As shown in FIG. 1, it is preferable that lead terminals such as high-voltage tabs are drawn out from the exterior body.

### Second Embodiment

In a battery pack of a second embodiment, filler materials are provided in gaps between cells and gaps between the cells and an exterior body. In addition, gaps are rarely present between a frame member and an electrode facing portion.

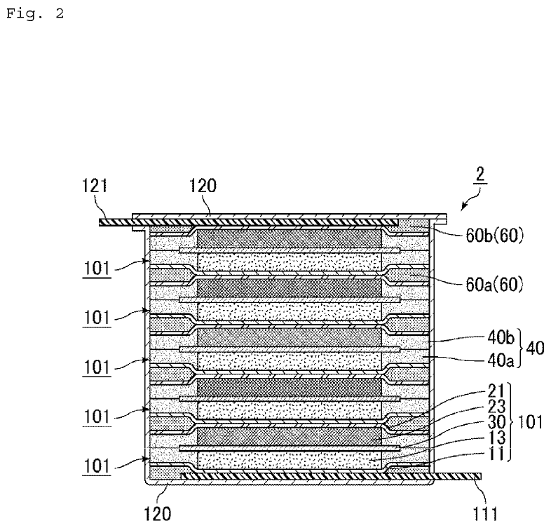

FIG. 2 is a cross-sectional view schematically showing another example of the battery pack of the present invention.

In a battery pack 2 shown in FIG. 2, the positions of the frame members 40 in the cell 101 are positions adjacent to the positive electrode active material layer 13 and the negative electrode active material layer 23. Therefore, gaps are rarely present between the frame member and the electrode facing portion, and the filler materials 60 are not provided in those positions.

In the battery pack 2 of the second embodiment, the filler materials 60 (filler materials 60a) are provided in the gaps between cells 101. In addition, the filler material 60 (filler material 60b) is provided in a gap between the cell 101 that is positioned uppermost among the cells 101 and the exterior body 120. Similarly, the filler material 60 (filler material 60b) is provided in a gap between the cell 101 that is positioned lowermost among the cells 101 and the exterior body 120.

The battery pack of the second embodiment is also, similar to the battery pack of the first embodiment, capable of maintaining a state of the cells vertically adjacent to each other in the battery pack being in close contact with each other in a case where external vibrations are applied during the production, transportation or use of the battery.

### Third Embodiment

In a battery pack of a third embodiment, filler materials are provided in gaps between a cell and an exterior body. There are no gaps between the cells, and no filler materials are provided.

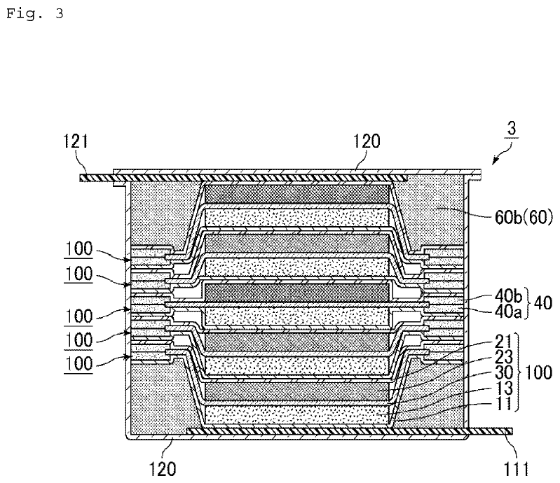

FIG. 3 is a cross-sectional view schematically showing still another example of the battery pack of the present invention.

In a battery pack 3 shown in FIG. 3, the cells 100 shown in the first embodiment are laminated together. At the time of laminating the cells, the cells are laminated so as not to generate a gap between the positive electrode resin current collector 11 and the adjacent negative electrode resin current collector 21 in each portion in contact with the frame member 40.

Since the thickness of the frame member is thinner than the thickness of the lamination unit (electrode facing portion), wide gaps are generated between the cell 100 and the exterior body 120 on the upper side and the lower side of the laminated frame members 40. In the battery pack 3 of the third embodiment, the filler materials 60 (filler materials 60b) are provided in the gaps between the cell 100 and the exterior body 120.

When the battery pack includes the filler materials in the gaps between the cell and the exterior body, it is possible to maintain a state of the cells vertically adjacent to each other in the battery pack being in close contact with each other in a case where external vibrations are applied during the production, transportation or use of the battery.

The cells that are used in the battery pack of the third embodiment are not limited to the cells shown in the first embodiment, and the cells shown in the second embodiment may also be used.

### Fourth Embodiment

In a battery pack of a fourth embodiment, filler materials are provided in gaps between cells. There are no gaps between the cell and an exterior body, and no filler materials are provided.

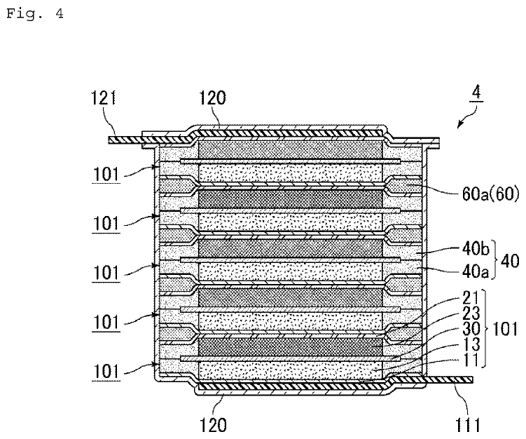

FIG. 4 is a cross-sectional view schematically showing far still another example of the battery pack of the present invention.

In a battery pack 4 shown in FIG. 4, the cells 101 shown in the second embodiment are laminated together. At the time of laminating the cells, the filler materials 60a are provided in the gaps between the cells 101.

In addition, no filler materials are provided in the gaps between the cell 101 and the exterior body 120. In a case where the exterior body 120 is made of a flexible material, the exterior body 120 can be transformed along the shape of the surface of the cell 101, and thus no gaps are generated between the cell 101 and the exterior body 120.

When the battery pack includes the filler materials in the gaps between the cells, it is possible to maintain a state of the cells vertically adjacent to each other in the battery pack being in close contact with each other in a case where external vibrations are applied during the production, transportation or use of the battery.

The cells that are used in the battery pack of the fourth embodiment are not limited to the cells shown in the second embodiment, and the cells shown in the first embodiment may also be used.

A method for manufacturing the battery pack of the present invention is not particularly limited, and the battery pack of the present invention can be obtained by producing cells and providing filler materials in necessary places in the process of laminating the cells.

For example, a plurality of cells are laminated to obtain a laminate, and a filler material may be poured into each gap between the cells from a side surface of the laminate. In addition, before the circumference of the laminate is sealed with an exterior body, filler materials are applied to positions where a gap is generated between the exterior body and the cell on the upper surface and the lower surface of the laminate, and the laminate may be then sealed with the exterior body.

The laminate can be sealed with the exterior body by heat sealing. In addition, at the time of the sealing with the exterior body, the laminate is preferably put into a vacuum state.

In addition, a laminate having a filler material provided in each gap between the cells may be obtained by repeating a step of applying a filler material to the circumference of a cell in a predetermined thickness, laminating another cell thereon, applying a filler material to the circumference of the laminated cell in a predetermined thickness at the time of laminating the cells.

When the filler materials are provided in the gaps between the cells and/or the gaps between the cell and the exterior body and the circumference of the laminate is then sealed with the exterior body, since gaps are rarely present in the battery pack, it is possible to achieve a state where the resin current collectors of the vertically adjacent cells are in close contact with each other.

As a result, it is possible to maintain a state of the cells vertically adjacent to each other in the battery pack being in close contact with each other in a case where external vibrations are applied during the production, transportation or use of the battery.

### EXAMPLES

Next, the present invention will be specifically described with examples, but the present invention is not limited to the examples within the scope of the gist of the present invention. Unless particularly otherwise described, “parts” means “parts by weight” and “%” means “weight”.

### [Production of Polymer Compound for Coating]

150 Parts of DMF was charged into a four-neck flask including a stirrer, a thermometer, a reflux cooling tube, a dropping funnel and a nitrogen gas introduction tube and heated to 75° C. Next, a monomer composition in which 91 parts of acrylic acid, 9 parts of methyl methacrylate and 50 parts of DMF were blended together and an initiator solution containing 0.3 parts of 2,2′-azobis (2,4-dimethylvaleronitrile) and 0.8 parts of 2,2′-azobis (2-methylbutyronitrile) dissolved in 30 parts of DMF were continuously added dropwise with the dropping funnel for two hours under stirring while nitrogen was blown into the four-neck flask to perform radical polymerization. After the end of the dropwise addition, a reaction was continued for three hours at 75° C. Next, the temperature was raised to 80° C., and the reaction was continued for three hours, thereby obtaining a copolymer solution having a resin concentration of 30%. The obtained copolymer solution was moved to a TEFLON (registered trademark) tray and vacuum-dried at 150° C. and 0.01 MPa for three hours to distill DMF away, thereby obtaining a copolymer. This copolymer was roughly crushed with a hammer and then additionally crushed with a mortar, thereby obtaining a powdery polymer compound for coating.

### [Production of Electrolytic Solution]

LiFSI (LIN(FSO₂)₂) was dissolved in a solvent mixture of ethylene carbonate (EC) and propylene carbonate (PC) (volume ratio between EC and PC=3:7) in a proportion of 2.0 mol/L to produce an electrolytic solution.

### [Production of Resin Current Collector]

70 Parts of polypropylene [trade name “SUNALLOMER PL500A” manufactured by SunAllomer Ltd.], 25 parts of carbon nanotubes [trade name “FloTube 9000” manufactured by Jiangsu Cnano Technology Co., Ltd.] and 5 parts of a dispersant [trade name “UMEX 1001” manufactured by Sanyo Chemical Industries, Ltd.] were melt-kneaded with a twin screw extruder under conditions of 200° C. and 200 rpm, thereby obtaining a resin mixture.

The obtained resin mixture was passed through a T die extrusion film-forming machine and stretch-rolled, thereby obtaining a conductive film for a resin current collector having a film thickness of 50 μm. Next, the obtained conductive film for a resin current collector was cut to be 400 mm×500 mm, and nickel deposition was performed on a single surface, thereby obtaining a resin current collector.

### [Production of Coated Negative Electrode Active Material Particles]

One part of the polymer compound for coating was dissolved in 3 parts of DMF, thereby obtaining a solution of the polymer compound for coating.

76 Parts of negative electrode active material particles (hard carbon powder, volume-average particle diameter: 25 μm) were put into an all-purpose mixer HIGH SPEED MIXER FS25 [manufactured by EarthTechnica Co., Ltd.], and 9 parts of the solution of the polymer compound for coating was added dropwise to the negative electrode active material particles in a state of being stirred at room temperature and 720 rpm for two minutes and further stirred for five minutes.

Next, 9 parts of acetylene black [DENKA BLACK (registered trademark) manufactured by Denka Company Limited.], which was a conductive agent, 2 parts of carbon nanofibers [manufactured by Teijin Limited.] and 4 parts of glass ceramic particles (trade name “Lithium-Ion Conducting Glass-Ceramics LICGC TMPW-01 (1 μm)” [manufactured by Ohara Inc.], volume-average particle diameter: 1000 nm) were injected into the solution in a stirred state for two minutes while being divided, and stirring was continued for 30 minutes.

After that, the pressure was reduced to 0.01 MPa while the stirring was maintained, next, the temperature was raised up to 140° C. while the stirring and the degree of pressure reduction were maintained, and the stirring, the degree of pressure reduction and the temperature were maintained for eight hours to distill a volatile component away.

The obtained powder was classified with a sieve having a mesh size of 200 μm, thereby obtaining coated negative electrode active material particles.

### [Production of Coated Positive Electrode Active Material Particles]

One part of the polymer compound for coating was dissolved in 3 parts of DMF, thereby obtaining a solution of the polymer compound for coating.

84 Parts of positive electrode active material particles (LiNi_{0.8}Co_{0.15}Al_{0.05}O₂ powder, volume-average particle diameter: 4 μm) were put into the all-purpose mixer HIGH SPEED MIXER FS25 [manufactured by EarthTechnica Co., Ltd.], and 9 parts of the solution of the polymer compound for coating was added dropwise to the positive electrode active material particles in a state of being stirred at room temperature and 720 rpm for two minutes and further stirred for five minutes.

Next, 3 parts of acetylene black [DENKA BLACK (registered trademark) manufactured by Denka Company Limited.], which was a conductive agent, and 4 parts of glass ceramic particles [trade name” Lithium-Ion Conducting Glass-Ceramics LICGC TMPW-01 (1 μm)”, manufactured by Ohara Inc.] were injected into the solution in a stirred state for two minutes while being divided, and stirring was continued for 30 minutes.

After that, the pressure was reduced to 0.01 MPa while the stirring was maintained, next, the temperature was raised up to 140° C. while the stirring and the degree of pressure reduction were maintained, and the stirring, the degree of pressure reduction and the temperature were maintained for eight hours to distill a volatile component away.

The obtained powder was classified with the sieve having a mesh size of 200 μm, thereby obtaining coated positive electrode active material particles.

### [Production of Negative Electrode]

A negative electrode frame member (inner dimensions: 37 cm×40 cm, outer dimensions: 38.6 cm×41.4 cm) was prepared by forming a polyolefin resin in a square ring shape.

42 Parts of the electrolytic solution and 4.2 parts of carbon fibers [DONACARBO Milled S-243 manufactured by Osaka Gas Chemicals Co., Ltd.: average fiber length: 500 μm, average fiber diameter: 13 μm, electrical conductivity: 200 mS/cm] were mixed using a planetary stirring-type kneading machine {Awatori Rentaro [manufactured by THINKY Corporation]} at 2000 rpm for five minutes, subsequently, 30 parts of the electrolytic solution and 206 parts of the coated negative electrode active material particles were added thereto and then further mixed together with the Awatori Rentaro at 2000 rpm for two minutes, 20 parts of the electrolytic solution was further added thereto and then stirred using the Awatori Rentaro at 2000 rpm for one minute, furthermore, 2.3 parts of the electrolytic solution was added thereto and then stirred using the Awatori Rentaro at 2000 rpm for two minutes, thereby producing a negative electrode active material composition.

The negative electrode frame member was disposed on the resin current collector, and the negative electrode active material composition was applied to the inside of the frame formed by the negative electrode frame member, thereby producing a negative electrode. The amount of the negative electrode active material composition applied was adjusted so that the thickness of a negative electrode active material layer became thicker than the thickness of the negative electrode frame member by approximately 200 to 500 μm.

In addition, the electrolytic solution was poured into the negative electrode active material layer.

### [Production of Positive Electrode]

A positive electrode frame member (inner dimensions: 37 cm×40 cm, outer dimensions: 38.6 cm×41.4 cm) was prepared by forming a polyolefin resin in a square ring shape.

42 Parts of the electrolytic solution and 4.2 parts of carbon fibers [DONACARBO Milled S-243 manufactured by Osaka Gas Chemicals Co., Ltd.: average fiber length: 500 μm, average fiber diameter: 13 μm, electrical conductivity: 200 mS/cm] were mixed using a planetary stirring-type kneading machine {Awatori Rentaro [manufactured by THINKY Corporation]} at 2000 rpm for five minutes, subsequently, 30 parts of the electrolytic solution and 206 parts of the coated positive electrode active material particles were added thereto and then further mixed together with the Awatori Rentaro at 2000 rpm for two minutes, 20 parts of the electrolytic solution was further added thereto and then stirred using the Awatori Rentaro at 2000 rpm for one minute, furthermore, 2.3 parts of the electrolytic solution was added thereto and then stirred using the Awatori Rentaro at 2000 rpm for two minutes, thereby producing a positive electrode active material composition.

The positive electrode frame member was disposed on the resin current collector, and the positive electrode active material composition was applied to the inside of the frame formed by the positive electrode frame member, thereby producing a positive electrode. The amount of the positive electrode active material composition applied was adjusted so that the thickness of a positive electrode active material layer became thicker than the thickness of the positive electrode frame member by approximately 200 to 500 μm.

In addition, the electrolytic solution was poured into the positive electrode active material layer.

### [Production of Cell]

The manufactured negative electrode and positive electrode and a separator were combined and overlapped, and portions where a positive electrode frame member and a negative electrode frame member overlapped were heat-sealed by being heated and pressurized, thereby producing a cell. As the separator, #3501 manufactured by CELGARD was used.

### [Production of Filler Materials]

A resin material and the following gas adsorption particles as necessary were mixed together in proportions shown in Table 1, thereby producing filler materials.

The specifications of the resin materials are as described below.
Resin material 1: LOCTITE (registered trademark) EA-60HP, manufacturer: Henkel AG & Co. KGaA.
Resin material 2: SUPER XL black No. 8008, manufacturer: CEMEDINE Co., Ltd.
Resin material 3: CEMEDINE (registered trademark) EP007, manufacturer: CEMEDINE Co., Ltd.
Resin material 4: CEMEDINE (registered trademark) 575F, manufacturer: CEMEDINE Co., Ltd.
The specifications of the gas adsorption particles are as described below.
Activated carbon 1: Product name “powdered activated carbon KD-PWSP”, volume-average particle diameter: 6 μm, manufacturer: UES Co., Ltd.
Activated carbon 2: Product name “powdered activated carbon KD-CAB”, volume-average particle diameter: 100 μm, manufacturer: UES Co., Ltd.
Zeolite 1: Product name “Molecular Sieves 5A Powder”, volume-average particle diameter: 8 μm, manufacturer: Tomoe Engineering Co., Ltd.
Zeolite 2: Product name “Zeoal 4A”, volume-average particle diameter: 0.045 μm, manufacturer: Nakamura Choukou Co., Ltd.
Alumina 1: Product name “activated alumina AA-101”, volume-average particle diameter: 12 μm, manufacturer: Nippon Light Metal Co., Ltd.
Silica 1: Product name “silica powder”, volume-average particle diameter: 50 μm, manufacturer: Maruto Co., Ltd.

### Example 1

### [Production of Battery Pack]

40 cells were laminated together to obtain a laminate. High-voltage tabs were joined to the upper and lower surfaces of the laminate.

In addition, the filler material was poured into each gap between the cells.

Before the circumference of the laminate was sealed with an exterior body, the filler materials were poured into positions where a gap is generated between the exterior body and the cell on the upper surface and the lower surface of the laminate, the laminate was put into an aluminum laminate film as the exterior body, and the outer circumference was heat-sealed, thereby producing a battery pack.

The battery pack obtained by the above-described step becomes a battery pack according to the composition schematically shown in FIG. 2.

In Example 1, as the filler materials, filler materials having a composition containing no gas adsorption particles were used.

### Examples 2 to 10

Battery packs were produced in the same manner as in Example 1 except that filler materials having a composition containing gas adsorption particles as shown in Table 1 were used as the filler materials.

### Examples 11 to 13

Battery packs were produced in the same manner as in Example 1 except that filler materials having a composition in which the kind of the resin material was changed as shown in Table 1 and gas adsorption particles were not contained were used as the filler materials.

### Comparative Example 1

A battery pack was produced without pouring filler materials into all of the gaps between cells and the gaps between an exterior body and the cell.

Regarding the filler materials used in each example, the tensile shear strength between the filler material and a PET plate was measured according to JIS K 6850.

Two PET plates that were 100 mm in length, 25 mm in width and 3 mm in thickness were prepared as adherends, and the two PET plates were made to adhere to a region that was 25 mm in width and 12.5 mm in length as an adhesive region with the filler materials having a thickness of 0.2 mm.

The adhering PET plates were pulled apart in a 180-degree direction, and the tensile shear strength was measured using a force gauge (AD-4932A-50N: manufactured by A&D Company, Limited).

### The Measurement Results are Summarized in Table 1.

Heating and vibration tests were performed on the battery pack manufactured in each of the examples and the comparative example, and the characteristics of the battery pack before and after the test were evaluated. The evaluation results are summarized in Table 1.

### [Heating and Vibration Tests]

A heating test was performed by holding the battery pack in a constant temperature bath at 72° C. for 60 hours. The battery pack that had undergone the heating test was fixed to a vibration tester (V8-440 metric SHAKER), and 7 Hz-200 Hz-7 Hz vibrations were imparted 12 times for 15 minutes in each of the X, Y and Z directions. The testing time was set to nine hours in total (three hours per each direction). These heating and vibration tests are tests according to T2 (thermal test) and T3 (vibration test) of the UN 38.3 Transportation Testing for Lithium-Ion Batteries.

### [Evaluation of Internal Resistance Value Before and After Heating and Vibration Tests]

The terminals of a BATTERY HiTESTER (manufactured by Hioki E. E. Corporation, BT3563A) were connected to the high-voltage tabs of the battery pack after the tests, and the internal resistance value (Q/MD: resistance value per battery pack) at 1000 Hz was measured in a state where the temperature was adjusted to 25° C.

The internal resistance value was also measured from the battery pack before the heating and vibrations tests.

[Evaluation of Positional Deviation after Heating and Vibration Tests]

The laminate of the cells was removed from the exterior body, and the positional deviation of the cells when seen from the upper surface of the laminate was measured.

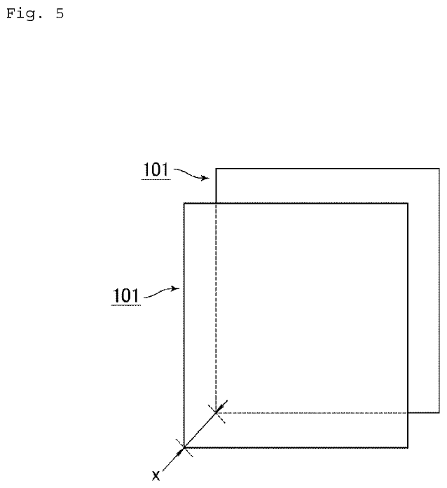

FIG. 5 is a schematic view showing the position where the positional deviation of the cells was measured.

As shown in FIG. 5, the positional deviation of the plurality of cells 101 was measured from the length [mm]indicated by both arrows X.

[Evaluation of Breakage of Resin Current Collectors after Heating and Vibration Tests]

The laminate was disassembled to remove the cells one by one, and whether the resin current collectors were broken or not was observed.

TABLE 1

| | | | | Gas adsorption particles in filler material | | | |
|---|---|---|---|---|---|---|---|
| | | | Tensile shear | | | | Volume- |
| | | | strength between | | | | average |
| | Presence or | | filler material | | | Weight | particle |
| | absence of | Kind of | and PET | Present | | proportion | diameter |
| | filler material | resin material | [N/mm²] | or absent | Kind | [weight %] | [μm] |
| Example 1 | Present | Resin material 1 | 0.16 or more | Absent | — | — | — |
| Example 2 | Present | Resin material 1 | 0.11 | Present | Activated carbon 1 | 20 | 6 |
| Example 3 | Present | Resin material 1 | 0.14 | Present | Alumina 1 | 20 | 12 |
| Example 4 | Present | Resin material 1 | 0.15 | Present | Zeolite 1 | 20 | 8 |
| Example 5 | Present | Resin material 1 | 0.13 | Present | Zeolite 1 | 30 | 8 |
| Example 6 | Present | Resin material 1 | 0.1 | Present | Zeolite 1 | 50 | 8 |
| Example 7 | Present | Resin material 1 | 0.03 | Present | Zeolite 1 | 80 | 8 |
| Example 8 | Present | Resin material 1 | 0.15 | Present | Zeolite 2 | 30 | 0.045 |
| Example 9 | Present | Resin material 1 | 0.06 | Present | Silica 1 | 30 | 50 |
| Example 10 | Present | Resin material 1 | 0.02 | Present | Activated carbon 2 | 30 | 100 |
| Example 11 | Present | Resin material 2 | 0.02 | Absent | — | — | — |
| Example 12 | Present | Resin material 3 | 0.05 | Absent | — | — | — |
| Example 13 | Present | Resin material 4 | 0.16 or more | Absent | — | — | — |
| Comparative | Absent | — | — | Absent | — | — | — |
| Example 1 | | | | | | | |

| | Evaluation items | | | |
|---|---|---|---|---|
| | Internal resistance | Internal resistance | Positional | |
| | value | value | deviation | Breakage of |
| | [before tests: | [after tests: | after tests | resin current |
| | Ω/MD] | Ω/MD] | [mm] | collector |
| Example 1 | 0.5 | 30 | 1 mm or less | No |
| Example 2 | 0.3 | 10 | 1 mm or less | No |
| Example 3 | 0.3 | 17 | 1 mm or less | No |
| Example 4 | 0.3 | 9 | 1 mm or less | No |
| Example 5 | 0.3 | 7 | 1 mm or less | No |
| Example 6 | 0.3 | 5 | 1 mm or less | No |
| Example 7 | 0.3 | 22 | 3 mm | No |
| Example 8 | 0.3 | 7 | 1 mm or less | No |
| Example 9 | 0.3 | 8 | 1 mm or less | No |
| Example 10 | 0.3 | 25 | 5 mm | No |
| Example 11 | 0.5 | 70 | 4 mm | No |
| Example 12 | 0.5 | 30 | 1 mm or less | No |
| Example 13 | 0.5 | 30 | 1 mm or less | No |
| Comparative | 0.5 | 2000 | 20 mm | Yes |
| Example 1 | | | | |

Compared with the battery pack of Comparative Example 1, for the battery pack of each example, the internal resistance value after the heating and vibration tests became significantly low. It is considered that, in the battery pack of Comparative Example 1, the close contact state of the resin current collectors became poor due to the heating and vibration tests and the internal resistance value increased; however, in the battery pack of each example, the positional deviation of the vertically adjacent cells was prevented, and thus an increase in the internal resistance value of the battery pack was prevented.

In addition, in the battery pack of Comparative Example 1, breakage occurred in the resin current collectors; however, in the battery pack of each example, breakage did not occur in the resin current collectors.

In Examples 2 to 10 where the filler material contained the gas adsorption particles, the internal resistance values became lower than those in Example 1 and Examples 11 to 13 where the filler material contained no gas adsorption particles.

Particularly, in Examples 5, 6, 8 and 9 where the weight proportion of the gas adsorption particles was within a range of 30 to 50 weight % based on the weight of the filler material, the internal resistance values became particularly low.

In Example 7, since the proportion of the gas adsorption particles in the filler material was too large, the strength of the filler material was insufficient, positional deviation was likely to occur, and the internal resistance value also became slightly high.

In Example 10, since the volume-average particle diameter of the gas adsorption particles was large, it became difficult to fill the gaps between the cells with the filler materials, positional deviation was likely to occur, and the internal resistance value also became slightly high.

In addition, in Examples 1 to 6, Examples 8 and 9 and Examples 12 and 13 where the tensile shear strength between the filler material and the PET was 0.05 N/mm² or higher, positional deviation after the tests became particularly small.

Hereinafter, another aspect of a resin current collector for a lithium ion battery and a lithium ion battery will be disclosed.

While a lithium ion battery is repeatedly charged and discharged, a side reaction occurs between the electrolytic solution and an electrode active material, and a gas is generated in the battery. This gas creates a problem of the deterioration of the lithium ion battery due to the occurrence of the gas-induced swelling of the battery or an increase in the internal resistance value.

In order to solve this problem, studies of providing a space for gas release in batteries, installing a separate gas adsorption layer or adding a gas adsorbent to electrode active material layers as in Japanese Patent Application Publication No. 2004-227818 and Japanese Patent Application Publication No. 2020-149794 have been made.

However, in lithium ion batteries for which a high capacity and a high energy density are required, there is a problem in that the addition of a gas adsorbent to an electrode active material layer decreases the energy density.

Hereinafter, a resin current collector for a lithium ion battery that has been made to solve the above-described problem, has a high energy density and is capable of suppressing an increase in the internal resistance value of the battery caused by gases that are generated in association with the charge and discharge of lithium ion batteries will be disclosed.

A resin current collector for a lithium ion battery to be disclosed below (hereinafter, also referred to as the resin current collector for a lithium ion battery of the present disclosure) is a resin current collector for a lithium ion battery composed of a resin composition containing a polyolefin resin, a conductive filler and gas adsorption particles, in which a weight proportion of the gas adsorption particles is 5 to 20 weight % based on a weight of the resin current collector for a lithium ion battery and the gas adsorption particles are one or more selected from the group consisting of activated carbon, zeolite, silica and alumina. In addition, a lithium ion battery including the resin current collector for a lithium ion battery will also be disclosed.

The resin current collector for a lithium ion battery of the present disclosure becomes a resin current collector for a lithium ion battery having a high energy density and being capable of suppressing an increase in the internal resistance value of the battery caused by gases that are generated in association with the charge and discharge of lithium ion batteries.

The resin current collector for a lithium ion battery of the present disclosure is a resin current collector for a lithium ion battery composed of a resin composition containing a polyolefin resin, a conductive filler and gas adsorption particles, in which a weight proportion of the gas adsorption particles is 5 to 20 weight % based on a weight of the resin current collector for a lithium ion battery and the gas adsorption particles are one or more selected from the group consisting of activated carbon, zeolite, silica and alumina.

In the resin current collector for a lithium ion battery of the present disclosure, the above-described kind of gas adsorption particles are added to the current collector in the above-described proportion. Therefore, in a lithium ion battery produced using the resin current collector for a lithium ion battery of the present disclosure, it is possible to adsorb a gas that is generated in association with the charge and discharge of the lithium ion battery with the gas adsorption particles that are contained in the current collector.

Therefore, it is possible to suppress an increase in the internal resistance value of the lithium ion battery caused by the gas.

Furthermore, since the resin current collector for a lithium ion battery of the present disclosure contains the gas adsorption particles, it is possible to sufficiently adsorb the gas at the time of producing a lithium ion battery even when no gas adsorption particles are added to the electrode active material layer. That is, the use of the resin current collector for a lithium ion battery of the present disclosure decreases the necessity of adding gas adsorption particles to the electrode active material layer.

In a case where the electrode active material layer contains no gas adsorption particles, since it is possible to increase the density of an active material in the electrode active material layer, the energy density can be improved.

In the resin current collector for a lithium ion battery of the present disclosure, the film thickness is preferably 25 to 500 μm and more preferably 30 to 60 μm.

When the film thickness of the resin current collector for a lithium ion battery is too thin, the resin current collector for a lithium ion battery is likely to break.

When the film thickness of the resin current collector for a lithium ion battery is too thick, at the time of producing a lithium ion battery using the resin current collector for a lithium ion battery, the proportion of the resin current collector becomes high, the proportion of the electrode active material layer becomes low, and the energy density decreases. Therefore, the film thickness of the current collector for a lithium ion battery is preferably as thin as possible, and the film thickness is more preferably 60 μm or less from the viewpoint of increasing the energy density.

The resin current collector for a lithium ion battery of the present disclosure can be used as a positive electrode current collector and can also be used as a negative electrode current collector.

Hereinafter, each configuration of the resin current collector for a lithium ion battery of the present disclosure will be described in detail.

### (Polyolefin Resin)

In the resin current collector for a lithium ion battery of the present disclosure, the polyolefin resin is a resin configuring the mother body (matrix resin) of the resin current collector for a lithium ion battery.

Examples of the polyolefin resin include polyolefins [polyethylene (PE), polypropylene (PP), polymethylpentene (PMP), polycycloolefin (PCO) and the like]. More preferably, examples thereof include polyethylene (PE), polypropylene (PP) and polymethylpentene (PMP).

In addition, the polyolefin resin in the present disclosure may be a modified product (hereinafter, referred to as the modified polyolefin) or mixture of the polyolefin resin.

As the polyolefin resin, for example, the following polyolefin resins can be procured from the market.
PE: “NOVATEC LL UE320” and “NOVATECT LL UJ960” both manufactured by Japan Polyethylene Corporation
PP: “SUNALLOMER PM854X”, “SUNALLOMER PC684S”, “SUNALLOMER PL500A”, “SUNALLOMER PC630S”, “SUNALLOMER PC630A”, “SUNALLOMER PB522M” and “QUALIA CM688A” all manufactured by SunAllomer Ltd., “PRIME POLYMER J-2000GP” manufactured by Prime Polymer Co., Ltd. and “WINTEC WFX4T” manufactured by Japan Polypropylene Corporation
PMP: “TPX” manufactured by Mitsui Chemicals, Inc.

Examples of the modified polyolefin include polyolefins obtained by introducing a polar functional group into polyethylene, polypropylene or a copolymer thereof, and examples of the polar functional group include a carboxyl group, a 1,3-dioxo-2-oxapropylene group, a hydroxyl group, an amino group, an amide group, an imide group and the like.

As examples of the modified polyolefins obtained by introducing the polar functional group into polyethylene, polypropylene or a copolymer thereof, ADMER series manufactured by Mitsui Chemicals, Inc. and the like are commercially available.

The matrix resin of the resin current collector for a lithium ion battery of the present disclosure may contain, aside from the polyolefin resin, a resin such as a polyamide (PA, for example, nylon 6, nylon 6,6 or the like), polymethylpentene (PMP), polyethylene terephthalate (PET), polyethernitrile (PEN), polytetrafluoroethylene (PTFE), styrene butadiene rubber (SBR), polyacrylonitrile (PAN), polymethyl acrylate (PMA), polymethyl methacrylate (PMMA), polyvinylidene fluoride (PVdF), an epoxy resin or a silicone resin.

The melting point of the matrix resin is preferably 150° C. to 230° C. and more preferably 155° C. to 225° C.

In the resin current collector for a lithium ion battery of the present disclosure, the weight proportion of the matrix resin is preferably 50 to 90 weight % and more preferably 50 to 70 weight % based on the weight of the resin current collector for a lithium ion battery.

When the weight proportion of the matrix resin is less than 50 weight %, there are cases where the strength of the resin current collector for a lithium ion battery becomes weak.

When the weight proportion of the matrix resin exceeds 90 weight %, the weight proportion of the conductive filler becomes relatively small, and the conductivity of the resin current collector for a lithium ion battery is likely to deteriorate.

### (Conductive Filler)

In the resin current collector for a lithium ion battery of the present disclosure, the conductive filler is not particularly limited as long as the conductive filler is a conductive material, and at least one selected from materials to be listed below is preferable.

Specific examples thereof include metals [nickel, aluminum, stainless steel (SUS), silver, copper, titanium and the like], carbon [graphite, carbon black (acetylene black, Ketjen black, furnace black, channel black, thermal lamp black and the like) and the like], mixtures thereof and the like but are not limited thereto.

These conductive fillers may be used singly or two or more thereof may be jointly used. In addition, an alloy or metal oxide thereof may also be used. From the viewpoint of the electrical stability, aluminum, stainless steel, carbon, silver, copper, titanium and mixtures thereof are preferable, silver, aluminum, stainless steel and carbon are more preferable, and carbon is still more preferable. In addition, these conductive fillers may be particulate ceramic materials or resin materials having a surround coated with a conductive material (a metal conductive filler among the above-described conductive fillers) by plating or the like.

In the resin current collector for a lithium ion battery of the present disclosure, the weight proportion of the conductive filler is preferably 10 to 40 weight % and more preferably 15 to 20 weight % based on the weight of the resin current collector for a lithium ion battery.

When the weight proportion of the conductive filler is too small, the conductivity of the resin current collector for a lithium ion battery is likely to deteriorate.

When the weight proportion of the conductive filler is too large, the weight proportion of the matrix resin becomes relatively small, and the strength of the weight proportion of the matrix resin becomes weak.

In the resin current collector for a lithium ion battery of the present disclosure, the volume-average particle diameter of the conductive filler is preferably 1 to 15 μm, more preferably 3 to 10 μm and still more preferably 5 to 8 μm.

When the volume-average particle diameter of the conductive filler is within the above-described range, the conductivity of the resin current collector for a lithium ion battery of the present disclosure becomes favorable.

The volume-average particle diameter of particles (the conductive filler, gas adsorption particles to be described below and the like) means the particle diameter at a cumulative value of 50% (Dv50) in a particle size distribution obtained by the microtrac method (laser diffraction and scattering method). The microtrac method is a method by which particle size distributions are obtained using scattered light that is obtained by irradiating particles with laser light. MICROTRAC manufactured by Nikkiso Co., Ltd. or the like can be used for the measurement of the volume-average particle diameter of particles.

### (Gas Adsorption Particles)

In the resin current collector for a lithium ion battery of the present disclosure, the gas adsorption particles are one or more selected from the group consisting of activated carbon, zeolite, silica and alumina. In addition, the gas adsorption particles are porous.

Gas adsorption particles composed of these substances are capable of suitably adsorbing gases that are generated in association with the charge and discharge of lithium ion batteries.

In the resin current collector for a lithium ion battery of the present disclosure, the weight proportion of the gas adsorption particles is preferably 5 to 20 weight % based on the weight of the resin current collector for a lithium ion battery. This weight proportion is preferably 10 to 20 weight % and more preferably 10 to 15 weight %.

When the weight proportion of the gas adsorption particles is less than 5 weight %, it becomes difficult to sufficiently adsorb gases that are generated in association with the charge and discharge of lithium ion batteries, and the internal resistance values of lithium ion batteries are likely to increase.

When the weight proportion of the gas adsorption particles exceed 20 weight %, the weight proportion of the matrix resin becomes relatively small, and there are cases where the strength of the matrix resin becomes weak.

In the resin current collector for a lithium ion battery of the present disclosure, the volume-average particle diameter of the gas adsorption particles is preferably 0.04 to 20 μm and more preferably 0.04 to 8 μm.

Gas adsorption particles having a volume-average particle diameter of smaller than 0.04 μm are difficult to produce.

When the volume-average particle diameter of the gas adsorption particles exceeds 20 μm, it becomes difficult for the matrix resin to make the gas adsorption particles adhere to each other. Therefore, the strength of the resin current collector for a lithium ion battery is likely to decrease.

In the resin current collector for a lithium ion battery of the present disclosure, the specific surface area of the gas adsorption particles is preferably 100 to 2000 m²/g and more preferably 300 to 900 m²/g.

When the specific surface area of the gas adsorption particles is within the above-described range, it is possible to suitably adsorb gases that are generated in association with the charge and discharge of lithium ion batteries.

The specific surface area of the gas adsorption particles is a value measured as a BET specific surface area according to “Determination of the specific surface area of powders (solids) by gas adsorption-BET method of JIS Z 8830”. The resin current collector for a lithium ion battery of the present disclosure may contain different components (a dispersant, a crosslinking accelerator, a crosslinking agent, a colorant, an ultraviolet absorber, a plasticizer and the like) other than the polyolefin resin, the conductive filler and the gas adsorption particles.

A method for producing the resin current collector for a lithium ion battery of the present disclosure is not particularly limited and can be produced by, for example, the following method.

A polyolefin resin, a conductive filler, gas adsorption particles and different components as necessary are mixed together, thereby obtaining a resin composition.

Examples of a mixing method include a method in which a masterbatch of the conductive filler and the gas adsorption particles is obtained and then the matrix resin is further mixed therewith, a method in which all of the raw materials are collectively mixed together and the like. The mixing can be performed by mixing pellet-like or powder-like components using an appropriate well-known mixer, for example, a kneader, an internal mixer, a Banbury mixer or a roll.

The addition order of each component during the mixing is not particularly limited. The obtained mixture may be further pelletized or powdered with a pelletizer or the like.

The obtained resin composition is formed into, for example, a film shape, thereby obtaining a resin current collector for a lithium ion battery. Examples of a method for forming the resin composition into a film shape include well-known film-forming methods such as a T die method, an inflation method and a calender method. The resin current collector for a lithium ion battery can also be obtained by a forming method other than film formation.

### [Lithium Ion Battery]

A lithium ion battery of the present disclosure includes the resin current collector for a lithium ion battery of the present disclosure.

The resin current collector for a lithium ion battery of the present disclosure can be applied to well-known lithium ion batteries.

That is, as materials for a positive electrode active material, a negative electrode active material, an electrolytic solution, a separator and the like, well-known materials can be used.

The positive electrode active material may be a coated positive electrode active material obtained by coating a positive electrode active material with a resin such as an acrylic resin, and the negative electrode active material may be a coated negative electrode active material obtained by coating a negative electrode active material with a resin such as an acrylic resin.

In the lithium ion battery of the present disclosure, the resin current collector for a lithium ion battery of the present disclosure may be used as at least one of a current collector for a positive electrode and a current collector for a negative electrode. In addition, both the current collector for the positive electrode and the current collector for the negative electrode may be the resin current collector for a lithium ion battery of the present disclosure.

In a case where the resin current collector for a lithium ion battery of the present disclosure is used as one of the current collector for the positive electrode and the current collector for the negative electrode, the other current collector may be a metal current collector or may be a resin current collector other than the resin current collector for a lithium ion battery of the present disclosure.

In the case of using a metal current collector, a material of the current collector may be a metal material such as copper, aluminum, titanium, stainless steel, nickel or an alloy thereof.

Next, an example of the above-described resin current collector for a lithium ion battery of the present disclosure will be specifically described. Unless particularly otherwise described, “parts” means “parts by weight”.

### Example 14

### [Production of Electrolytic Solution]

LiFSI was dissolved in a solvent mixture of ethylene carbonate (EC) and propylene carbonate (PC) (volume ratio=1:1) in a proportion of 2.0 mol/L to produce an electrolytic

### Solution

### [Production of Resin Current Collector for Positive Electrode]

65 Parts of polypropylene [trade name “SUNALLOMER PL500A” manufactured by SunAllomer Ltd.] as the polyolefin resin, 20 parts of carbon black [trade name: SuperP, manufactured by TIMCAL Graphite & Carbon] as the conductive filler, 10 parts of zeolite 3 [trade name “Zeoal 4A”: average particle diameter: 0.045 μm, manufactured by Nakamura Choukou Co., Ltd.] as the gas adsorption particles and 5 parts of a dispersant [trade name “UMEX 1001” manufactured by Sanyo Chemical Industries, Ltd.] were melt-kneaded with a twin screw extruder under conditions of 200° C. and 200 rpm, thereby obtaining a resin mixture.

The obtained resin mixture was passed through a T die extrusion film-forming machine and stretch-rolled, thereby obtaining a conductive film for a resin current collector having a film thickness of 30 μm. Next, the obtained conductive film for a resin current collector was cut to be 17.0 cm×17.0 cm, nickel deposition was performed on a single surface, and terminals for current extraction (5 mm×3 cm) were then connected to the conductive film for a resin current collector, thereby obtaining a resin current collector for a positive electrode according to Example 14.

### [Production of Coated Positive Electrode Active Material Particles]

150 Parts of DMF (N, N-dimethylformamide) was charged into a four-neck flask including a stirrer, a thermometer, a reflux cooling tube, a dropping funnel and a nitrogen gas introduction tube and heated to 75° C. Next, a monomer composition in which 91 parts of acrylic acid, 9 parts of methyl methacrylate and 50 parts of DMF were blended together and an initiator solution containing 0.3 parts of 2,2′-azobis (2,4-dimethylvaleronitrile) and 0.8 parts of 2,2′-azobis (2-methylbutyronitrile) dissolved in 30 parts of DMF were continuously added dropwise with the dropping funnel for two hours under stirring while nitrogen was blown into the four-neck flask to perform radical polymerization. After the end of the dropwise addition, a reaction was continued for three hours at 75° C. Next, the temperature was raised to 80° C., and the reaction was continued for three hours, thereby obtaining a copolymer solution having a resin concentration of 30%. The obtained copolymer solution was moved to a TEFLON (registered trademark) tray and vacuum-dried at 150° C. and 0.01 MPa for three hours to distill DMF away, thereby obtaining a copolymer. This copolymer was roughly crushed with a hammer and then additionally crushed with a mortar, thereby obtaining a powdery polymer compound for coating.

Next, one part of the polymer compound for coating was dissolved in 3 parts of DMF, thereby obtaining a solution of the polymer compound for coating.

84 Parts of positive electrode active material particles (LiNi_{0.8}Co_{0.15}Al_{0.05}O₂ powder, volume-average particle diameter: 4 μm) were put into the all-purpose mixer HIGH SPEED MIXER FS25 [manufactured by EarthTechnica Co., Ltd.], and 9 parts of the solution of the polymer compound for coating was added dropwise to the positive electrode active material particles in a state of being stirred at room temperature and 720 rpm for two minutes and further stirred for five minutes.

Next, 3 parts of acetylene black [DENKA BLACK (registered trademark) manufactured by Denka Company Limited.], which was an auxiliary conductive agent, and 4 parts of glass ceramic particles (trade name “Lithium-Ion Conducting Glass-Ceramics LICGC TMPW-01 (1 μm)” [manufactured by Ohara Inc.]) were injected into the solution in a stirred state for two minutes while being divided, and stirring was continued for 30 minutes.

After that, the pressure was reduced to 0.01 MPa while the stirring was maintained, next, the temperature was raised up to 140° C. while the stirring and the degree of pressure reduction were maintained, and the stirring, the degree of pressure reduction and the temperature were maintained for eight hours to distill a volatile component away.

The obtained powder was classified with the sieve having a mesh size of 200 μm, thereby obtaining coated positive electrode active material particles according to Example 14.

### [Production of Positive Electrode for Lithium Ion Battery]

42 Parts of the electrolytic solution and 4.2 parts of carbon fibers [DONACARBO Milled S-243 manufactured by Osaka Gas Chemicals Co., Ltd.: average fiber length: 500 μm, average fiber diameter: 13 μm, electrical conductivity: 200 mS/cm] were mixed using a planetary stirring-type kneading machine {Awatori Rentaro [manufactured by THINKY Corporation]} at 2000 rpm for five minutes, subsequently, 30 parts of the electrolytic solution and 206 parts of the coated positive electrode active material particles were added thereto and then further mixed together with the planetary stirring-type kneading machine at 2000 rpm for two minutes, 20 parts of the electrolytic solution was further added thereto and then stirred using the planetary stirring-type kneading machine at 2000 rpm for one minute, furthermore, 2.3 parts of the electrolytic solution was added thereto and then mixed by stirring using the planetary stirring-type kneading machine at 2000 rpm for two minutes, thereby producing a slurry for a positive electrode active material layer. The obtained slurry for a positive electrode active material layer was applied to a single surface of the resin current collector for a positive electrode so that the basis weight reached 80 mg/cm² and pressed with a pressure of 1.4 MPa for approximately 10 seconds, thereby producing a positive electrode for a lithium ion battery (16.2 cm×16.2 cm) according to Example 14 having a thickness of 340 μm.

### [Production of Resin Current Collector for Negative Electrode]

70 Parts of polypropylene [trade name “SUNALLOMER PL500A” manufactured by SunAllomer Ltd.], 25 parts of carbon black [trade name: SuperP, manufactured by TIMCAL Graphite & Carbon] and 5 parts of a dispersant [trade name “UMEX 1001” manufactured by Sanyo Chemical Industries, Ltd.] were melt-kneaded with a twin screw extruder under conditions of 200° C. and 200 rpm, thereby obtaining a resin mixture.

The obtained resin mixture was passed through a T die extrusion film-forming machine and stretch-rolled, thereby obtaining a conductive film for a resin current collector having a film thickness of 100 μm. Next, the obtained conductive film for a resin current collector was cut to be 17.0 cm×17.0 cm, and nickel deposition was performed on a single surface, and terminals for current extraction (5 mm×3 cm) were then connected to the conductive film for a resin current collector, thereby obtaining a resin current collector for a negative electrode according to Example 14.

### [Production of Coated Negative Electrode Active Material Particles]

One part of the polymer compound for coating was dissolved in 3 parts of DMF, thereby obtaining a solution of the polymer compound for coating.

76 Parts of negative electrode active material particles (hard carbon powder, volume-average particle diameter: 25 μm) were put into an all-purpose mixer HIGH SPEED MIXER FS25 [manufactured by EarthTechnica Co., Ltd.], and 9 parts of the solution of the polymer compound for coating was added dropwise to the negative electrode active material particles in a state of being stirred at room temperature and 720 rpm for two minutes and further stirred for five minutes.

Next, 9 parts of acetylene black [DENKA BLACK (registered trademark) manufactured by Denka Company Limited.], which was an auxiliary conductive agent, 2 parts of carbon nanofibers [manufactured by Teijin Limited.] and 4 parts of glass ceramic particles (trade name “Lithium-Ion Conducting Glass-Ceramics LICGC TMPW-01 (1 μm)” [manufactured by Ohara Inc.], (1 μm)) were injected into the solution in a stirred state for two minutes while being divided, and stirring was continued for 30 minutes.

After that, the pressure was reduced to 0.01 MPa while the stirring was maintained, next, the temperature was raised up to 140° C. while the stirring and the degree of pressure reduction were maintained, and the stirring, the degree of pressure reduction and the temperature were maintained for eight hours to distill a volatile component away.

The obtained powder was classified with the sieve having a mesh size of 200 μm, thereby obtaining coated negative electrode active material particles according to Example 14.

### [Production of Negative Electrode for Lithium Ion Battery]

42 Parts of the electrolytic solution and 4.2 parts of carbon fibers [DONACARBO Milled S-243 manufactured by Osaka Gas Chemicals Co., Ltd.: average fiber length: 500 μm, average fiber diameter: 13 μm, electrical conductivity: 200 mS/cm] were mixed using a planetary stirring-type kneading machine {Awatori Rentaro [manufactured by THINKY Corporation]} at 2000 rpm for five minutes, subsequently, 30 parts of the electrolytic solution and 206 parts of the coated negative electrode active material particles were added thereto and then further mixed together with the planetary stirring-type kneading machine at 2000 rpm for two minutes, 20 parts of the electrolytic solution was further added thereto and then stirred using the planetary stirring-type kneading machine at 2000 rpm for one minute, furthermore, 2.3 parts of the electrolytic solution was added thereto and then mixed by stirring using the planetary stirring-type kneading machine at 2000 rpm for two minutes, thereby producing a slurry for a negative electrode active material layer. The obtained slurry for a negative electrode active material layer was applied to a single surface of the resin current collector for a negative electrode so that the basis weight reached 80 mg/cm² and pressed with a pressure of 1.4 MPa for approximately 10 seconds, thereby producing a negative electrode for a lithium ion battery (16.2 cm×16.2 cm) according to Example 14 having a thickness of 340 μm.

### [Production of Lithium Ion Battery]

The obtained positive electrode for a lithium ion battery and negative electrode for a lithium ion battery were combined together through a separator (CELGARD #3501) to produce a laminate cell, thereby producing a lithium ion battery according to Example 14.

### (Example 15) to (Example 31) and (Comparative Example 2) to (Comparative Example 4)

Resin current collectors for a positive electrode according to Examples 15 to 31 and Comparative Examples 2 to 4 were produced in the same manner as in Example 14 except that the kinds and proportions of the polyolefin resin, the conductive filler and the gas adsorption particles that were used in the [production of resin current collector for positive electrode] and the film thickness of the resin current collector for a positive electrode were changed as shown in Table 2.

Lithium ion batteries were produced using the resin current collectors for a positive electrode.

In Comparative Example 4, it was not possible to form a film of the resin current collector for a positive electrode.

This is considered to be because the content of the gas adsorption particles was too large and thus the content of the polyolefin resin, which was the matrix resin, became small, which made it impossible to make the gas adsorption particles, the conductive filler or the like adhere.

### Example 32

A lithium ion battery according to Example 32 was produced in the same manner as in Example 14 except that the followings were used as the resin current collector for a positive electrode and the resin current collector for a negative electrode.

### [Production of Resin Current Collector for Positive Electrode]

70 Parts of polypropylene [trade name “SUNALLOMER PL500A” manufactured by SunAllomer Ltd.], carbon black [trade name: SuperP, manufactured by TIMCAL Graphite & Carbon] and 5 parts of a dispersant [trade name “UMEX 1001” manufactured by Sanyo Chemical Industries, Ltd.] were melt-kneaded with a twin screw extruder under conditions of 200° C. and 200 rpm, thereby obtaining a resin mixture.

The obtained resin mixture was passed through a T die extrusion film-forming machine and stretch-rolled, thereby obtaining a conductive film for a resin current collector having a film thickness of 100 μm. Next, the obtained conductive film for a resin current collector was cut to be 17.0 cm×17.0 cm, nickel deposition was performed on a single surface, and terminals for current extraction (5 mm×3 cm) were then connected to the conductive film for a resin current collector, thereby obtaining a resin current collector for a positive electrode according to Example 32.

### [Production of Resin Current Collector for Negative Electrode]

65 Parts of polypropylene [trade name “SUNALLOMER PL500A” manufactured by SunAllomer Ltd.] as the polyolefin resin, 20 parts of carbon black [trade name: SuperP, manufactured by TIMCAL Graphite & Carbon] as the conductive filler, 10 parts of zeolite 4 [trade name “Molecular Sieves 5A Powder”: average particle diameter: 8 μm, manufactured by Tomoe Engineering Co., Ltd.] as the gas adsorption particles and 5 parts of a dispersant [trade name “UMEX 1001” manufactured by Sanyo Chemical Industries, Ltd.] were melt-kneaded with a twin screw extruder under conditions of 200° C. and 200 rpm, thereby obtaining a resin mixture.

The obtained resin mixture was passed through a T die extrusion film-forming machine and stretch-rolled, thereby obtaining a conductive film for a resin current collector having a film thickness of 50 μm. Next, the obtained conductive film for a resin current collector was cut to be 17.0 cm×17.0 cm, and nickel deposition was performed on a single surface, and terminals for current extraction (5 mm×3 cm) were then connected to the conductive film for a resin current collector, thereby obtaining a resin current collector for a negative electrode according to Example 32.

TABLE 2

| | Electrode where resin current collector shown in table is used | | | | | | |
|---|---|---|---|---|---|---|---|
| | Positive electrode | Gas adsorption particles | | | Polyolefin | | |
| | resin current collector | | Particle | Content | resin | Dispersant | Conductive filler |
| | or negative electrode | | diameter | (parts by | (parts by | (parts by | (parts by |
| | resin current collector | Kind | (μm) | weight) | weight) | weight) | weight) |
| Example 14 | Positive electrode | Zeolite 3 | 0.045 | 10 | 65 | 5 | 20 |
| Example 15 | Positive electrode | Zeolite 4 | 8 | 10 | 65 | 5 | 20 |
| Example 16 | Positive electrode | Zeolite 5 | 20 | 10 | 65 | 5 | 20 |
| Example 17 | Positive electrode | Silica 2 | 9 | 10 | 65 | 5 | 20 |
| Example 18 | Positive electrode | Silica 3 | 19 | 10 | 65 | 5 | 20 |
| Example 19 | Positive electrode | Zeolite 6 | 8 | 10 | 65 | 5 | 20 |
| Example 20 | Positive electrode | Activated carbon 3 | 4 | 10 | 65 | 5 | 20 |
| Example 21 | Positive electrode | Alumina 2 | 12 | 10 | 65 | 5 | 20 |
| Example 22 | Positive electrode | Zeolite 4 | 8 | 20 | 60 | 5 | 15 |
| Example 23 | Positive electrode | Zeolite 4 | 8 | 5 | 70 | 5 | 20 |
| Example 24 | Positive electrode | Zeolite 4 | 8 | 15 | 65 | 5 | 15 |
| Example 25 | Positive electrode | Zeolite 4 | 8 | 15 | 60 | 5 | 20 |
| Example 26 | Positive electrode | Zeolite 4 | 8 | 10 | 65 | 5 | 20 |
| Example 27 | Positive electrode | Zeolite 4 | 8 | 10 | 65 | 5 | 20 |
| Example 28 | Positive electrode | Zeolite 4 | 8 | 10 | 65 | 5 | 20 |
| Example 29 | Positive electrode | Zeolite 7 | 40 | 10 | 65 | 5 | 20 |
| Example 30 | Positive electrode | Silica 4 | 38 | 10 | 65 | 5 | 20 |
| Example 31 | Positive electrode | Zeolite 4 | 8 | 10 | 75 | 5 | 10 |
| Example 32 | Negative electrode | Zeolite 4 | 8 | 10 | 65 | 5 | 20 |
| Comparative Example 2 | Positive electrode | — | — | 0 | 75 | 5 | 20 |
| Comparative Example 3 | Positive electrode | Zeolite 4 | 8 | 2 | 73 | 5 | 20 |
| Comparative Example 4 | Positive electrode | Zeolite 4 | 8 | 30 | 45 | 5 | 20 |

| | Evaluation items | | | | | |
|---|---|---|---|---|---|---|
| | | | Internal resistance value (Ω) | | | |
| | | Film | | | | Change |
| | Film | thickness | After | After | After | rate |
| | formability | (μm) | 0 days | 7 days | 14 days | (%) |
| Example 14 | ◯ | 30 | 3.1 | 3.7 | 4.35 | 140 |
| Example 15 | ◯ | 50 | 3.17 | 3.73 | 4.28 | 135 |
| Example 16 | ◯ | 60 | 3.12 | 3.81 | 4.51 | 145 |
| Example 17 | ◯ | 50 | 3.2 | 3.95 | 4.77 | 149 |
| Example 18 | ◯ | 60 | 3.21 | 3.84 | 4.6 | 143 |
| Example 19 | ◯ | 50 | 3.13 | 3.69 | 4.34 | 139 |
| Example 20 | ◯ | 40 | 3.18 | 3.72 | 4.24 | 133 |
| Example 21 | ◯ | 50 | 3.19 | 3.98 | 4.75 | 149 |
| Example 22 | ◯ | 60 | 3.36 | 3.89 | 4.49 | 134 |
| Example 23 | ◯ | 45 | 3.17 | 3.95 | 4.7 | 148 |
| Example 24 | ◯ | 55 | 3.38 | 3.91 | 4.56 | 135 |
| Example 25 | ◯ | 55 | 3.14 | 3.68 | 4.24 | 135 |
| Example 26 | ◯ | 50 | 3.3 | 4.15 | 4.87 | 148 |
| Example 27 | ◯ | 50 | 2.99 | 3.64 | 4.29 | 143 |
| Example 28 | ◯ | 50 | 2.96 | 3.78 | 4.88 | 165 |
| Example 29 | Δ | 70 | 4.01 | 5.04 | 5.68 | 142 |
| Example 30 | Δ | 70 | 4.08 | 5.14 | 5.87 | 144 |
| Example 31 | ◯ | 50 | 5.5 | 6.72 | 7.39 | 134 |
| Example 32 | ◯ | 50 | 3.16 | 3.66 | 4.23 | 134 |
| Comparative Example 2 | ◯ | 30 | 3.21 | 5.51 | 8.39 | 261 |
| Comparative Example 3 | ◯ | 40 | 3.17 | 4.7 | 6.12 | 193 |
| Comparative Example 4 | X | 80 | — | — | — | — |

The kinds of the gas adsorption particles in Table 2 are as described below.
Zeolite 3: Product name “Zeoal 4A”, average particle diameter: 0.045 μm, manufacturer: Nakamura Choukou Co., Ltd.
Zeolite 4: Product name “Molecular Sieves 5A Powder”, average particle diameter: 8 μm, manufacturer: Tomoe Engineering Co., Ltd.
Zeolite 5: Product name “Molecular Sieves 5A Pellet”, average particle diameter: 20 μm, manufacturer: Tomoe Engineering Co., Ltd.
Zeolite 6: Product name “Molecular Sieves 13X Powder”, average particle diameter: 8 μm, manufacturer: Tomoe Engineering Co., Ltd.
Zeolite 7: Product name “Molecular Sieves 5A Pellet”, average particle diameter: 40 μm, manufacturer: Tomoe Engineering Co., Ltd.
Silica 2: Product name “silica powder”, average particle diameter: 9 μm, manufacturer: Maruto Co., Ltd.
Silica 3: Product name “silica gel”, average particle diameter: 19 μm, manufacturer: Maruto Co., Ltd.
Silica 4: Product name “silica powder”, average particle diameter: 38 μm, manufacturer: Maruto Co., Ltd.
Activated carbon 3: Product name “powdered activated carbon KD-PWSSP”, average particle diameter: 4 μm, manufacturer: UES Co., Ltd.
Alumina 2: Product name “activated alumina AA-101”, average particle diameter: 12 μm, manufacturer: Nippon Light Metal Co., Ltd.
“Zeolite 5”, “Zeolite 7”, “Silica 2” and “Silica 4” were all crushed with a mortar, and the average particle diameters were arranged with a sieve.

### <Observation of Film Formability of Resin Current Collector>

The film formability of the resin current collectors for a positive electrode of Examples 14 to 31 and Comparative Examples 2 to 4 and the resin current collector for a negative electrode of Example 32 was visually observed. The evaluation criteria are as described below. The results are shown in Table 2.
O: A film can be formed, and the film thickness is 30 μm or more and less than 70 μm.
Δ: A film can be formed, and the film thickness is 70 μm or more.
X: A film cannot be formed.

### <Measurement of Internal Resistance Value>

The lithium ion battery obtained in each of the examples and the comparative examples was charged up to a voltage of 4.2 V at a constant current of 0.05 C at 25° C. using a charge and discharge measuring instrument “BATTERY ANALYZER 1470 TYPE” [manufactured by TOYO Corporation] and then charged until the current value reached 0.01 C in a constant voltage state of 4.2 V. After 10 seconds of a pause, the lithium ion battery was discharged to a voltage of 2.5 V at a constant current of 0.01 C and charged up to a voltage of 4.2 V at a constant current of 0.05C. Next, the charged lithium ion battery was stored under an environment of 60° C.

The internal resistance values at a frequency of 1000 Hz after zero days (immediately after full charge), after seven days of storage and after 14 days of storage were measured using an impedance measuring instrument (manufactured by Hioki E. E. Corporation, CHEMICAL IMPEDANCE ANALYZER IM3590). The results are shown in Table 2.

“Change rate” shown in Table 2 means the percentage of the internal resistance value after 14 days increased relative to the internal resistance value after zero day.

As shown in Table 2, it was clarified that, in the lithium ion battery of each example, the internal resistance value (Ω) was less likely to increase.

This is considered to be because the resin current collector for a positive electrode or the resin current collector for a negative electrode of each example contained the gas adsorption particles and was thus capable of adsorbing gases that were generated in association with the charge and discharge of the lithium ion battery and capable of preventing the occurrence of the gas-induced swelling of the battery that was caused by the gases.

Hereinafter, another aspect of the coated electrode active material particles for a lithium ion battery, an electrode for a lithium ion battery, the lithium ion battery and the method for manufacturing the coated electrode active material particles for a lithium ion battery will be disclosed.

While a lithium ion battery is repeatedly charged and discharged, a side reaction occurs between the electrolytic solution and an electrode active material, and a gas is generated in the battery. This gas creates a problem of the deterioration of the lithium ion battery due to the occurrence of the gas-induced swelling of the battery or an increase in the internal resistance value.

In order to solve this problem, studies of providing a space for gas release in batteries, installing a separate gas adsorption layer or adding a gas adsorbent to electrode active material layers as in Japanese Patent Application Publication No. 2004-227818 and Japanese Patent Application Publication No. 2020-149794 have been made.

However, even when a gas adsorbent is added to electrode active material layers as in Japanese Patent Application Publication No. 2004-227818 and Japanese Patent Application Publication No. 2020-149794, there has been a problem in that an increase in the internal resistance value cannot be sufficiently suppressed.

Hereinafter, coated electrode active material particles for a lithium ion battery that have been made to solve the above-described problem and are capable of suppressing an increase in the internal resistance values of batteries caused by gases that are generated in association with the charge and discharge of lithium ion batteries will be disclosed.

The coated electrode active material particles for a lithium ion battery to be disclosed below (hereinafter, also referred to as the coated electrode active material particles for a lithium ion battery of the present disclosure) are coated electrode active material particles for a lithium ion battery in which at least a part of the surface of each electrode active material particle is coated with a coating layer, in which the coating layer contains gas adsorption particles, a polymer compound and an auxiliary conductive agent, and the volume-average particle diameter of the gas adsorption particles is 0.04 to 20 μm. In addition, an electrode for a lithium ion battery including an electrode active material layer containing the coated electrode active material particles for a lithium ion battery and an electrolytic solution containing an electrolyte and a solvent, in which the electrode active material layer is made of an unbound body of the coated electrode active material particles for a lithium ion battery; a lithium ion battery including the electrode for a lithium ion battery; and a method for producing the coated electrode active material particles for a lithium ion battery having a mixing step of mixing electrode active material particles, a polymer compound, an auxiliary conductive agent, gas adsorption particles and an organic solvent to produce a composition for an electrode active material particle and a desolvation step of desolvating the composition for an electrode active material particle will also be disclosed.

The coated electrode active material particles for a lithium ion battery of the present disclosure are capable of suppressing an increase in the internal resistance values of batteries caused by gases that are generated in association with the charge and discharge of lithium ion batteries.

The coated electrode active material particles for a lithium ion battery of the present disclosure are coated electrode active material particles for a lithium ion battery in which at least a part of the surface of each electrode active material particle is coated with a coating layer, in which the coating layer contains gas adsorption particles, a polymer compound and an auxiliary conductive agent, and the volume-average particle diameter of the gas adsorption particles is 0.04 to 20 μm.

In the coated electrode active material particles for a lithium ion battery of the present disclosure, gas adsorption particles having the above-described size are contained in the coating layers that coat the electrode active material particles.

When an electrode for a lithium ion battery is produced using such coated electrode active material particles for a lithium ion battery, and a lithium ion battery is produced using the electrode for a lithium ion battery, the gas adsorption particles are capable of adsorbing gases even when the gases are generated in association with charge and discharge.

Therefore, it is possible to suppress an increase in the internal resistance value of the lithium ion battery.

This is considered to be because the gas adsorption particles are contained in the coating layers, whereby the gas adsorption particles are positioned at places where gas is likely to be adsorbed.

Furthermore, as a cause of an increase in the internal resistance value due to gases, the deterioration of the conductivity between the electrode active material particle and the coating layer due to gases retaining in the vicinity of the electrode active material particle can also be considered.

In the coated electrode active material particles for a lithium ion battery of the present disclosure, since the gas adsorption particles are contained in the coating layers, it is possible to prevent gases from retaining in the vicinities of the electrode active material particles. As a result, it is possible to suppress an increase in the internal resistance value of the lithium ion battery.

The volume-average particle diameter of the coated electrode active material particles for a lithium ion battery of the present disclosure is preferably 0.01 to 100 μm and more preferably 5 to 40 μm.

Coated electrode active material particles for a lithium ion battery having a volume-average particle diameter of less than 5 μm are difficult to produce.

When the volume-average particle diameter of the coated electrode active material particles for a lithium ion battery exceeds 40 μm, forming becomes difficult at the time of producing an electrode active material layer.

The volume-average particle diameter of particles (the coated electrode active material particles for a lithium ion battery, positive electrode active material particles, negative electrode active material particles, gas adsorption particles and the like) means the particle diameter at a cumulative value of 50% (Dv50) in a particle size distribution obtained by the microtrac method (laser diffraction and scattering method). The microtrac method is a method by which particle size distributions are obtained using scattered light that is obtained by irradiating particles with laser light. MICROTRAC manufactured by Nikkiso Co., Ltd. or the like can be used for the measurement of the volume-average particle diameter of particles.

In addition, the average particle diameter of the auxiliary conductive agent to be described below is measured by a different method.

Hereinafter, each configuration of the coated electrode active material particles for a lithium ion battery of the present disclosure will be described in detail.

### [Electrode Active Material Particles]

In the coated electrode active material particles for a lithium ion battery of the present disclosure, the electrode active material particles may be positive electrode active material particles or may be negative electrode active material particles.

In a case where the electrode active material particles are positive electrode active material particles, the coated electrode active material particles for a lithium ion battery of the present disclosure are used to produce a positive electrode.

In addition, in a case where the electrode active material particles are negative electrode active material particles, the coated electrode active material particles for a lithium ion battery of the present disclosure are used to produce a negative electrode.

In a case where the electrode active material particles are positive electrode active material particles, examples of the positive electrode active material particles include composite oxides of lithium and a transition metal {composite oxides containing one transition metal (LiCoO₂, LiNiO₂, LiAlMnO₄, LiMnO₂, LiMn₂O₄ and the like), composite oxides containing two transition metals (for example, LiFeMnO₄, LiNi₁₋ₓCoₓO₂, LiMn_{1-y}CO_{y}O₂, LiNi_{1/3}CO_{1/3}Al_{1/3}O₂ and LiNi_{0.8}Co_{0.15}Al_{0.05}O₂), composite oxides containing three or more transition metals [for example, LiMₐM′_{b}M″_{c}O₂(M, M′ and M″ are each a different transition metal element and a+b+c=1 is satisfied; for example, LiNi_{1/3}Mn_{1/3}CO_{1/3}O₂) and the like] and the like}, lithium-containing transition metal phosphates (for example, LiFePO₄, LiCoPO₄, LiMnPO₄ and LiNiPO₄), transition metal oxides (for example, MnO₂ and V₂O₅), transition metal sulfides (for example, MoS₂ and TiS₂), conductive polymers (for example, polyaniline, polypyrrole, polythiophene, polyacetylene, poly-p-phenylene and polyvinyl carbazole) and the like, and two or more thereof may be jointly used.

The lithium-containing transition metal phosphates may be lithium-containing transition metal phosphates in which some of the transition metal sites are substituted with a different transition metal.

From the viewpoint of the electrical characteristics of batteries, the volume-average particle diameter of the positive electrode active material particles is preferably 0.01 to 100 μm, more preferably 0.1 to 35 μm and still more preferably 2 to 30 μm.

In a case where the electrode active material particles are negative electrode active material particles, examples of the negative electrode active material particles include carbon-based materials [graphite, non-graphitizable carbon, amorphous carbon, fired resin bodies (for example, a body obtained by firing and carbonizing a phenol resin, a furan resin or the like and the like), cokes (for example, pitch coke, needle coke, petroleum coke and the like), carbon fibers and the like], silicon-based materials [silicon, silicon oxide (SiOₓ), silicon-carbon composites (carbon particles having surfaces coated with silicon and/or silicon carbide, silicon particles or silicon oxide particles having surfaces coated with carbon and/or silicon carbide, silicon carbide and the like), silicon alloys (a silicon-aluminum alloy, a silicon-lithium alloy, a silicon-nickel alloy, a silicon-iron alloy, a silicon-titanium alloy, a silicon-manganese alloy, a silicon-copper alloy, a silicon-tin alloy and the like) and the like], conductive polymers (for example, polyacetylene, polypyrrole and the like), metals (tin, aluminum, zirconium, titanium and the like), metal oxides (titanium oxide, lithium/titanium oxide and the like), metal alloys (for example, a lithium-tin alloy, a lithium-aluminum alloy, a lithium-aluminum-manganese alloy and the like), mixtures of the above-described negative electrode active material and a carbon-based material and the like.

Among the above-listed negative electrode active material particles, on negative electrode active material particles not containing lithium or a lithium ion therein, a pre-doping treatment for injecting lithium or a lithium ion into some or all of the negative electrode active material particles in advance may be performed.

From the viewpoint of the electrical characteristics of batteries, the volume-average particle diameter of the negative electrode active material particles is preferably 0.01 to 100 μm, more preferably 0.1 to 60 μm and still more preferably 2 to 40 μm.

### [Coating Layer]

In the coated electrode active material particles for a lithium ion battery of the present disclosure, the coating layers contain gas adsorption particles, a polymer compound and an auxiliary conductive agent.

### (Gas Adsorption Particles)

In the coated electrode active material particles for a lithium ion battery of the present disclosure, the gas adsorption particles are preferably one or more selected from the group consisting of activated carbon, zeolite, silica and alumina.

Gas adsorption particles composed of these substances are capable of suitably adsorbing gases that are generated in association with the charge and discharge of lithium ion batteries.

In the coated electrode active material particles for a lithium ion battery of the present disclosure, the weight proportion of the gas adsorption particles is preferably 0.3 to 6 weight % and more preferably 3 to 5 weight % based on the weight of the coated electrode active material particles.

When the weight proportion of the gas adsorption particles is less than 0.3 weight %, it becomes difficult to sufficiently adsorb gases that are generated in association with the charge and discharge of lithium ion batteries, and the internal resistance values of lithium ion batteries are likely to increase.

When the weight proportion of the gas adsorption particles exceed 6 weight %, since the proportion of the polymer compound becomes relatively small, the adhesive force of the coating layer decreases, and the coating layer is likely to peel off from the electrode active material particle.

In the coated electrode active material particles for a lithium ion battery of the present disclosure, the volume-average particle diameter of the gas adsorption particles is preferably 0.04 to 20 μm. In the present disclosure, even when the particles are composed of, for example, activated carbon, zeolite, silica or alumina, in a case where the volume-average particle diameter thereof is not within a range of 0.04 to 20 μm, the particles are not a gas adsorbent.

Particles having a volume-average particle diameter of smaller than 0.04 μm are difficult to produce as particles having gas adsorption performance.

Particles having a volume-average particle diameter exceeding 20 μm are too large, and it becomes difficult for the polymer compound to make the particles adhere to each other. Therefore, the strength of the coating layer is likely to decrease.

The volume-average particle diameter of the gas adsorption particles is preferably 0.04 to 12 μm and more preferably 0.04 to 4 μm.

In the coated electrode active material particles for a lithium ion battery of the present disclosure, the specific surface area of the gas adsorption particles is preferably 100 to 2000 m²/g and more preferably 300 to 900 m²/g.

When the specific surface area of the gas adsorption particles is within the above-described range, it is possible to suitably absorb gases that are generated in association with the charge and discharge of lithium ion batteries.

The specific surface area of the gas adsorption particles is a value measured as a BET specific surface area according to “Determination of the specific surface area of powders (solids) by gas adsorption-BET method of JIS Z 8830”.

### (Polymer Compound)

As the polymer compound, for example, a resin containing a polymer having an acrylic monomer (a) as an essential configuration monomer is preferable.

Specifically, the polymer compound that configures the coating layer is preferably a polymer of a monomer composition containing an acrylic acid (a0) as the acrylic monomer (a). In the monomer composition, the content of the acrylic acid (a0) is preferably more than 90 weight % and 98 weight % or less based on the weight of all monomers. From the viewpoint of the flexibility of the coating layer, the content of the acrylic monomer (a0) is more preferably 93.0 to 97.5 weight % and still more preferably 95.0 to 97.0 weight % based on the weight of all of the monomers.

The polymer compound that configures the coating layer may contain a monomer (a1) having a carboxyl group or an acid anhydride group other than the acrylic acid (a0) as the acrylic monomer (a).

Examples of the monomer (a1) having a carboxyl group or an acid anhydride group other than the acrylic acid (a0) include monocarboxylic acids having 3 to 15 carbon atoms such as methacrylic acid, crotonic acid and cinnamic acid; dicarboxylic acids having 4 to 24 carbon atoms such as (anhydrous) maleic acid, fumaric acid, (anhydrous) itaconic acid, citraconic acid and mesaconic acid; tri-, quadri-, or higher-valent polycarboxylic acids having 6 to 24 carbon atoms such as aconitic acid; and the like.

The polymer compound that configures the coating layer may contain a monomer (a2) represented by the following general formula (1) as the acrylic monomer (a).

CH₂=C(R¹)COOR² (1)

[In the formula (1), R¹ is a hydrogen atom or a methyl group, and R² is a linear alkyl group having 4 to 12 carbon atoms or a branched alkyl group having 3 to 36 carbon atoms.]

In the monomer (a2) represented by the general formula (1), R¹ represents a hydrogen atom or a methyl group. R¹ is preferably a methyl group.

R² is preferably a linear or branched alkyl group having 4 to 12 carbon atoms or a branched alkyl group having 13 to 36 carbon atoms.

Examples of the monomer (a2) include an ester compound (a21) in which R² is a linear or branched alkyl group having 4 to 12 carbon atoms and an ester compound (a22) in which R² is a branched alkyl group having 13 to 36 carbon atoms.

In the ester compound (a21) in which R² is a linear or branched alkyl group having 4 to 12 carbon atoms, examples of the linear alkyl group having 4 to 12 carbon atoms include a butyl group, a pentyl group, a hexyl group, a heptyl group, an octyl group, a nonyl group, a decyl group, an undecyl group and a dodecyl group.

Examples of the branched alkyl group having 4 to 12 carbon atoms include a 1-methylpropyl group (sec-butyl group), a 2-methylpropyl group, a 1,1-dimethylethyl group (tert-butyl group), a 1-methylbutyl group, a 1,1-dimethylpropyl group, a 1,2-dimethylpropyl group, a 2,2-dimethylpropyl group (neopentyl group), a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 1-ethylbutyl group, a 2-ethylbutyl group, a 1-methylhexyl group, a 2-methylhexyl group, a 3-methylhexyl group, a 4-methylhexyl group, a 5-methylhexyl group, a 1-ethylpentyl group, a 2-ethylpentyl group, a 3-ethylpentyl group, a 1,1-dimethylpentyl group, a 1,2-dimethylpentyl group, a 1,3-dimethylpentyl group, a 2,2-dimethylpentyl group, a 2,3-dimethylpentyl group, a 1-methylheptyl group, a 2-methylheptyl group, a 3-methylheptyl group, a 4-methylheptyl group, a 5-methylheptyl group, a 6-methylheptyl group, a 1,1-dimethylhexyl group, a 1,2-dimethylhexyl group, a 1,3-dimethylhexyl group, a 1,4-dimethylhexyl group, a 1,5-dimethylhexyl group, a 1-ethylhexyl group, a 2-ethylhexyl group, a 1-methyloctyl group, a 2-methyloctyl group, a 3-methyloctyl group, a 4-methyloctyl group, a 5-methyloctyl group, a 6-methyloctyl group, a 7-methyloctyl group, a 1,1-dimethylheptyl group, a 1,2-dimethylheptyl group, a 1,3-dimethylheptyl group, a 1,4-dimethylheptyl group, a 1,5-dimethylheptyl group, a 1,6-dimethylheptyl group, a 1-ethylheptyl group, a 2-ethylheptyl group, a 1-methylnonyl group, a 2-methylnonyl group, a 3-methylnonyl group, a 4-methylnonyl group, a 5-methylnonyl group, a 6-methylnonyl group, a 7-methylnonyl group, a 8-methylnonyl group, a 1,1-dimethyloctyl group, a 1,2-dimethyloctyl group, a 1,3-dimethyloctyl group, a 1,4-dimethyloctyl group, a 1,5-dimethyloctyl group, a 1,6-dimethyloctyl group, a 1,7-dimethyloctyl group, a 1-ethyloctyl group, a 2-ethyloctyl group, a 1-methyldecyl group, a 2-methyldecyl group, a 3-methyldecyl group, a 4-methyldecyl group, a 5-methyldecyl group, a 6-methyldecyl group, a 7-methyldecyl group, a 8-methyldecyl group, a 9-methyldecyl group, a 1,1-dimethylnonyl group, a 1,2-dimethylnonyl group, a 1,3-dimethylnonyl group, a 1,4-dimethylnonyl group, a 1,5-dimethylnonyl group, a 1,6-dimethylnonyl group, a 1,7-dimethylnonyl group, a 1,8-dimethylnonyl group, a 1-ethylnonyl group, a 2-ethylnonyl group, a 1-methylundecyl group, a 2-methylundecyl group, a 3-methylundecyl group, a 4-methylundecyl group, a 5-methylundecyl group, a 6-methylundecyl group, a 7-methylundecyl group, a 8-methylundecyl group, a 9-methylundecyl group, a 10-methylundecyl group, a 1,1-dimethyldecyl group, a 1,2-dimethyldecyl group, a 1,3-dimethyldecyl group, a 1,4-dimethyldecyl group, a 1,5-dimethyldecyl group, a 1,6-dimethyldecyl group, a 1,7-dimethyldecyl group, a 1,8-dimethyldecyl group, a 1,9-dimethyldecyl group, a 1-ethyldecyl group, a 2-ethyldecyl group and the like. Among these, particularly, a 2-ethylhexyl group is preferable.

In the ester compound (a22) in which R² is a branched alkyl group having 13 to 36 carbon atoms, examples of the branched alkyl group having 13 to 36 carbon atoms include 1-alkylalkyl groups [a 1-methyldodecyl group, a 1-butyleicosyl group, a 1-hexyloctadecyl group, a 1-octylhexadecyl group, a 1-decyltetradecyl group, a 1-undecyltridecyl group and the like], 2-alkylalkyl groups [a 2-methyldodecyl group, a 2-hexyloctadecyl group, a 2-octylhexadecyl group, a 2-decyltetradecyl group, a 2-undecyltridecyl group, a 2-dodecylhexadecyl group, a 2-tridecylpentadecyl group, a 2-decyloctadecyl group, a 2-tetradecyloctadecyl group, a 2-hexadecyloctadecyl group, a 2-tetradecyleicosyl group, a 2-hexadecyleicosyl group and the like], 3 to 34-alkylalkyl groups (a 3-alkylalkyl group, a 4-alkylalkyl group, a 5-alkylalkyl group, a 32-alkylalkyl group, a 33-alkylalkyl group, a 34-alkylalkyl group and the like), mixed alkyl groups having one or more branched alkyl groups such as residues obtained by removing a hydroxyl group from an oxo alcohol that is obtained from a propylene oligomer (heptamer to undecamer), an ethylene/propylene (molar ratio: 16/1 to 1/11) oligomer, an isobutylene oligomer (heptamer or octamer), an α-olefin (having 5 to 20 carbon atoms) oligomer (tetramer to octamer) or the like and the like.

The polymer compound that configures the coating layer may contain an ester compound (a3) of a monovalent aliphatic alcohol having 1 to 3 carbon atoms and (meth) acrylic acid as the acrylic monomer (a).

Examples of the monovalent aliphatic alcohol having 1 to 3 carbon atoms that configures the ester compound (a3) include methanol, ethanol, 1-propanol, 2-propanol and the like.

The (meth) acrylic acid means acrylic acid or methacrylic acid.

The polymer compound that configures the coating layer is preferably a polymer of a monomer composition containing at least one of the acrylic acid (a0), the monomer (a1), the monomer (a2) and the ester compound (a3), more preferably a polymer of a monomer composition containing at least one of the acrylic acid (a0), the monomer (a1), the ester compound (a21) and the ester compound (a3), still more preferably a polymer of a monomer composition containing any one of the acrylic acid (a0), the monomer (a1), the monomer (a2) and the ester compound (a3) and most preferably a polymer of a monomer composition containing any one of the acrylic acid (a0), the monomer (a1), the ester compound (a21) and the ester compound (a3).

Examples of the polymer compound that configures the coating layer include a copolymer of an acrylic acid and maleic acid in which the maleic acid is used as the monomer (a1), a copolymer of an acrylic acid and 2-ethylhexyl methacrylate in which the 2-ethylhexyl methacrylate is used as the monomer (a2), a copolymer of acrylic acid and methyl methacrylate in which the methyl methacrylate is used as the ester compound (a3) and the like.

From the viewpoint of suppressing the volume change of the positive electrode active material particles or the like, the total content of the monomer (a1), the monomer (a2) and the ester compound (a3) is preferably 2.0 to 9.9 weight % and more preferably 2.5 to 7.0 weight % based on the weight of all of the monomers.

The polymer compound that configures the coating layer preferably does not contain a salt (a4) of an anionic monomer having a polymerizable unsaturated double bond and an anionic group as the acrylic monomer (a).

Examples of a structure having the polymerizable unsaturated double bond include a vinyl group, an allyl group, a styrenyl group, a (meth) acryloyl group and the like.

Examples of the anionic group include a sulfonic acid group, a carboxyl group and the like.

The anionic monomer having a polymerizable unsaturated double bond and an anionic group is a compound obtained by combining the polymerizable unsaturated double bond and the anionic group, and examples thereof include vinylsulfonic acid, allylsulfonic acid, styrenesulfonic acid and (meth) acrylic acid.

The (meth) acryloyl group means an acryloyl group or a methacryloyl group.

Examples of a cation that configures the salt (a4) of an anionic monomer include a lithium ion, a sodium ion, a potassium ion, an ammonium ion and the like.

In addition, the polymer compound that configures the coating layer may contain a radical polymerizable monomer (a5) that can be copolymerized with the acrylic acid (a0), the monomer (a1), the monomer (a2) and the ester compound (a3) as the acrylic monomer (a) to an extent that the physical properties are not impaired.

The radical polymerizable monomer (a5) is preferably a monomer containing no active hydrogen, and the following monomers (a51) to (a58) can be used.

(a51) Hydrocarbyl (meth) acrylate formed of a linear aliphatic monool having 13 to 20 carbon atoms, an alicyclic monool having 5 to 20 carbon atoms or an aromatic aliphatic monool having 7 to 20 carbon atoms and (meth) acrylic acid

Examples of the monool include (i) linear aliphatic monools (tridecyl alcohol, myristyl alcohol, pentadecyl alcohol, cetyl alcohol, heptadecyl alcohol, stearyl alcohol, nonadecyl alcohol, arachidyl alcohol and the like), (ii) alicyclic monools (cyclopentyl alcohol, cyclohexyl alcohol, cycloheptyl alcohol, cyclooctyl alcohol and the like), (iii) aromatic aliphatic monools (benzyl alcohol and the like) and mixtures of two or more thereof.

(a52) Poly (n=2 to 30) oxyalkylene (having 2 to 4 carbon atoms) alkyl (having 1 to 18 carbon atoms) ether (meth) acrylates [(meth) acrylate to which 10 mol of ethylene oxide (hereinafter abbreviated as EO) of methanol is added, (meth) acrylate to which 10 mol of propylene oxide (hereinafter abbreviated as PO) of methanol is added and the like]

(a53) Nitrogen-containing vinyl compounds

(a53-1) Amide group-containing vinyl compound
(i) (Meth) acrylamide compounds having 3 to 30 carbon atoms, for example, N, N-dialkyl (having 1 to 6 carbon atoms) or diaralkyl (having 7 to 15 carbon atoms) (meth) acrylamide (N, N-dimethylacrylamide, N, N-dibenzylacrylamide and the like), diacetone acrylamide
(ii) Amide group-containing vinyl compounds having 4 to 20 carbon atoms excluding the above-listed (meth) acrylamide compounds, for example, N-methyl-N-vinylacetamide and cyclic amides [pyrrolidone compounds (having 6 to 13 carbon atoms, for example, N-vinylpyrrolidone and the like)]
   (a53-2) (Meth) acrylate compounds
(i) Dialkyl (having 1 to 4 carbon atoms) aminoalkyl (having 1 to 4 carbon atoms) (meth) acrylates [N, N-dimethylaminoethyl (meth) acrylate, N, N-diethylaminoethyl (meth) acrylate, t-butylaminoethyl (meth) acrylate, morpholinoethyl (meth) acrylate and the like]
(ii) Quaternized products of a quaternary ammonium group-containing (meth) acrylate {tertiary amino group-containing (meth) acrylates [N, N-dimethylaminoethyl (meth) acrylate, N, N-diethylaminoethyl (meth) acrylate or the like] (products quaternized using a quaternizing agent such as methyl chloride, dimethyl sulfate, benzyl chloride and dimethyl carbonate) and the like}
   (a53-3) Heterocycle-containing vinyl compounds

Pyridine compounds (having 7 to 14 carbon atoms, for example, 2- or 4-vinylpyridine), imidazole compounds (having 5 to 12 carbon atoms, for example, N-vinylimidazole), pyrrole compounds (having 6 to 13 carbon atoms, for example, N-vinylpyrrole), pyrrolidone compounds (having 6 to 13 carbon atoms, for example, N-vinyl-2-pyrrolidone)

(a53-4) Nitrile group-containing vinyl compounds

Nitrile group-containing vinyl compounds having 3 to 15 carbon atoms, for example, (meth) acrylonitrile, cyanostyrene, cyanoalkyl (having 1 to 4 carbon atoms) acrylates (a53-5) Other nitrogen-containing vinyl compounds

Nitro group-containing vinyl compounds (having 8 to 16 carbon atoms, for example, nitrostyrene) and the like.

(a54) Vinyl hydrocarbons
(a54-1) Aliphatic vinyl hydrocarbons

Olefins having 2 to 18 carbon atoms or more (ethylene, propylene, butene, isobutylene, pentene, heptene, diisobutylene, octene, dodecene, octadecene and the like), dienes having 4 to 10 carbon atoms or more (butadiene, isoprene, 1,4-pentadiene, 1,5-hexadiene, 1,7-octadiene and the like) and the like

(a54-2) Alicyclic vinyl hydrocarbons

Cyclic unsaturated compounds having 4 to 18 carbon atoms or more, for example, cycloalkenes (for example, cyclohexene), (di) cycloalkadienes [for example, (di) cyclopentadiene], terpenes (for example, pinene and limonene) and indenes

(a54-3) Aromatic vinyl hydrocarbons

Aromatic unsaturated compounds having 8 to 20 carbon atoms or more, for example, styrene, α-methylstyrene, vinyltoluene, 2,4-dimethylstyrene, ethylstyrene, isopropylstyrene, butylstyrene, phenylstyrene, cyclohexylstyrene and benzylstyrene

(a55) Vinyl esters

Aliphatic vinyl esters [having 4 to 15 carbon atoms, for example, alkenyl esters of an aliphatic carboxylic acid (mono-or dicarboxylic acid) (for example, vinyl acetate, vinyl propionate, vinyl butyrate, diallyl adipate, isopropenyl acetate and vinyl methoxy acetate)]

Aromatic vinyl esters [having 9 to 20 carbon atoms, for example, alkenyl esters of an aromatic carboxylic acid (mono-or dicarboxylic acid) (for example, vinyl benzoate, diallyl phthalate and methyl-4-vinyl benzoate), aromatic ring-containing esters of an aliphatic carboxylic acid (for example, acetoxystyrene)]

(a56) Vinyl ethers

Aliphatic vinyl ethers [having 3 to 15 carbon atoms, for example, vinyl alkyl (having 1 to 10 carbon atoms) ethers (vinyl methyl ether, vinyl butyl ether, vinyl 2-ethylhexyl ether and the like), vinyl alkoxy (having 1 to 6 carbon atoms) alkyl (having 1 to 4 carbon atoms) ethers (vinyl-2-methoxyethyl ether, methoxybutadiene, 3,4-dihydro-1,2-pyran, 2-butoxy-2′-vinyloxydiethyl ether, vinyl-2-ethylmercaptoethyl ether and the like), poly (two to four) (meth) allyloxyalkane (having 2 to 6 carbon atoms) (diallyloxyethane, triallyloxyethane, tetraallyloxybutane, tetramethallyloxyethane and the like)], aromatic vinyl ethers (having 8 to 20 carbon atoms, for example, vinyl phenyl ether and phenoxystyrene)

(a57) Vinyl ketones

Aliphatic vinyl ketones (having 4 to 25 carbon atoms, for example, vinyl methyl ketone and vinyl ethyl ketone) and aromatic vinyl ketones (having 9 to 21 carbon atoms, for example, vinyl phenyl ketone)

(a58) Unsaturated dicarboxylic acid diester

Unsaturated dicarboxylic acid diesters having 4 to 34 carbon atoms, for example, dialkyl fumarates (two alkyl groups are linear, branched or alicyclic groups having 1 to 22 carbon atoms), dialkyl maleates (two alkyl groups are linear, branched or alicyclic groups having 1 to 22 carbon atoms)

In the case of containing the radical polymerizable monomer (a5), the content thereof is preferably 0.1 to 3.0 weight % based on the weight of all of the monomers.

A preferable lower limit of the weight-average molecular weight of the polymer compound that configures the coating layer is 3,000, a more preferable lower limit is 5,000 and a still more preferable lower limit is 7,000. On the other hand, a preferable upper limit of the weight-average molecular weight of the polymer compound is 100,000 and a more preferable upper limit is 70,000.

The weight-average molecular weight of the polymer compound that configures the coating layer can be obtained by measurement by gel permeation chromatography (hereinafter, abbreviated as GPC) under the following conditions.
Device: Alliance GPC V2000 (manufactured by Waters Corporation)
Solvent: Orthodichlorobenzene, DMF, THF
Standard substance: Polystyrene
Sample concentration: 3 mg/ml
Column stationary phase: PLgel 10 μm, two MIXED-B's in series (manufactured by Polymer Laboratories Ltd.)
Column temperature: 135° C.

The polymer compound that configures the coating layer can be produced by a well-known polymerization method (bulk polymerization, solution polymerization, emulsion polymerization, suspension polymerization or the like) using a well-known polymerization initiator {an azo initiator [2,2′-azobis (2-methylpropionitrile), 2,2′-azobis (2,4-dimethylvaleronitrile), 2,2′-azobis (2-methylbutyronitrile) or the like], a peroxide-based initiator (benzoyl peroxide, di-t-butyl peroxide, lauryl peroxide or the like) or the like}.

The amount of the polymerization initiator used is preferably 0.01 to 5 weight %, more preferably 0.05 to 2 weight % and still more preferably 0.1 to 1.5 weight % based on the total weight of the monomers from the viewpoint of adjusting the weight-average molecular weight to a preferable range or the like. The polymerization temperature and the polymerization time are adjusted depending on the kind of the polymerization initiator or the like, and the polymerization is performed at a polymerization temperature of preferably −5° C. to 150° C. (more preferably 30° C. to)120° C. for a reaction time of preferably 0.1 to 50 hours (more preferably two to 24 hours).

Examples of a solvent that is used in the case of solution polymerization include esters (having 2 to 8 carbon atoms, for example, ethyl acetate and butyl acetate), alcohols (having 1 to 8 carbon atoms, for example, methanol, ethanol and octanol), hydrocarbons (having 4 to 8 carbon atoms, for example, n-butane, cyclohexane and toluene), amides (for example, N, N-dimethylformamide (hereinafter, abbreviated as DMF)) and ketones (having 3 to 9 carbon atoms, for example, methyl ethyl ketone). From the viewpoint of adjusting the weight-average molecular weight to a preferable range or the like, the amount of the solvent used is preferably 5 to 900 weight %, more preferably 10 to 400 weight % and still more preferably 30 to 300 weight % based on the total weight of the monomers, and the monomer concentration is preferably 10 to 95 weight %, more preferably 20 to 90 weight % and still more preferably 30 to 80 weight %.

Examples of a dispersion medium in emulsion polymerization and suspension polymerization include water, alcohols (for example, ethanol), esters (for example, ethyl propionate), light naphtha and the like. Examples of an emulsifier include higher fatty acid (having 10 to 24 carbon atoms) metal salts (for example, sodium oleate and sodium stearate), higher alcohol (having 10 to 24 carbon atoms) sulfate ester metal salts (for example, sodium lauryl sulfate), ethoxylated tetramethyldecynediol, sodium sulfoethyl methacrylate, dimethylaminomethyl methacrylate and the like. Furthermore, a polyvinyl alcohol, polyvinyl pyrrolidone or the like may be added as a stabilizer.

The monomer concentration of a solution or a dispersion is preferably 5 to 95 weight %, more preferably 10 to 90 weight % and still more preferably 15 to 85 weight %, and the amount of the polymerization initiator used is preferably 0.01 to 5 weight % and more preferably 0.05 to 2 weight % based on the total weight of the monomers.

At the time of polymerization, a well-known chain transfer agent, for example, a mercapto compound (dodecyl mercaptan, n-butyl mercaptan or the like) and/or a halogenated hydrocarbon (carbon tetrachloride, carbon tetrabromide, benzyl chloride or the like) can be used.

The polymer compound that configures the coating layer may be a crosslinked polymer obtained by crosslinking with a crosslinking agent (A′) having a reactive functional group that makes the polymer compound react with a carboxyl group {preferably a polyepoxy compound (a′1) [polyglycidyl ether (bisphenol A diglycidyl ether, propylene glycol diglycidyl ether, glycerin triglycidyl ether or the like), a polyglycidyl amine (N, N-diglycidylaniline or 1,3-bis (N, N-diglycidyl aminomethyl)) or the like] and/or a polyol compound (a′ 2) (ethylene glycol or the like)}.

Examples of a method for crosslinking the polymer compound that configures the coating layer using the crosslinking agent (A′) include a method in which positive electrode active material particles are coated with the polymer compound that configures the coating layer and then crosslinked. Specific examples thereof include a method in which positive electrode active material particles and a resin solution containing the polymer compound that configures the coating layer are mixed together and desolvated to produce coated positive electrode active material particles and a solution containing the crosslinking agent (A′) is then mixed with the coated active material particles and heated to cause a crosslinking reaction with a desolvating agent, thereby causing a reaction that crosslinks the polymer compound that configures the coating layer with the crosslinking agent (A′) on the surfaces of the positive electrode active material particles.

The heating temperature is adjusted depending on the kind of the crosslinking agent, is preferably 70° C. or higher in the case of using the polyepoxy compound (a′1) as the crosslinking agent, and is preferably 120° C. or higher in the case of using the polyol compound (a′ 2).

### (Auxiliary Conductive Agent)

The auxiliary conductive agent is preferably selected from conductive materials.

Preferable examples of the auxiliary conductive agent include metals [aluminum, stainless steel (SUS), silver, gold, copper, titanium and the like], carbons [graphite, carbon black (acetylene black, Ketjen black, furnace black, channel black, thermal lamp black and the like) and the like], mixtures thereof and the like.

These auxiliary conductive agents may be used singly or two or more thereof may be jointly used. In addition, these auxiliary conductive agents may be used as an alloy or metal oxide thereof.

Among them, from the viewpoint of the electrical stability, aluminum, stainless steel, carbons, silver, gold, copper, titanium and mixtures thereof are more preferable, silver, gold, aluminum, stainless steel and carbons are still more preferable and carbons are particularly preferable.

In addition, these auxiliary conductive agents may be particulate ceramic materials or resin materials having a surround coated with a conductive material [preferably a metal auxiliary conductive agent among the above-described auxiliary conductive agents] by plating or the like.

The shape (form) of the auxiliary conductive agent is not limited to the particle form, may be a form other than the particle form and may be a form that has been put into practical use as a so-called filler-based auxiliary conductive agent such as a carbon nanofiber or a carbon nanotube.

The average particle diameter of the auxiliary conductive agent is not particularly limited, but is preferably approximately 0.01 to 10 μm from the viewpoint of the electrical characteristics of the battery.

“The particle diameter of the auxiliary conductive agent” means the maximum distance L among the distances between two arbitrary points on the contour line of the auxiliary conductive agent. As the value of “the average particle diameter”, a value that is calculated as the average value of the particle diameters of the particles that are observed in a several to several tens of visual fields using observation means such as a scanning electron microscope (SEM) or a transmission electron microscope (TEM) is used.

The ratio between the polymer compound that configures the coating layer and the auxiliary conductive agent is not particularly limited, but the weight ratio between the polymer compound that configures the coating layer (the weight of the resin solid content) and the auxiliary conductive agent is preferably 1:0.01 to 1:50 and more preferably 1:0.2 to 1:3.0 from the viewpoint of the internal resistance value of the battery or the like.

In the coated electrode active material particles for a lithium ion battery of the present disclosure, the coating layers may further contain ceramic particles.

Examples of the ceramic particles include metal carbide particles, metal oxide particles, glass ceramic particles and the like.

Examples of the metal carbide particles include silicon carbide (Sic), tungsten carbide (WC), molybdenum carbide (MO₂C), titanium carbide (Tic), tantalum carbide (TaC), niobium carbide (NbC), vanadium carbide (VC), zirconium carbide (ZrC) and the like.

Examples of the metal oxide particles include zinc oxide (ZnO), aluminum oxide (Al₂O₃), silicon dioxide (SiO₂), tin oxide (SnO₂), titania (TiO₂), zirconia (ZrO₂), indium oxide (In₂O₃), Li₂B₄O₇, Li₄Ti₅O₁₂, Li₂Ti₂O₅, LiTaO₃, LINbO₃, LiAlO₂, Li₂ZrO₃, Li₂WO₄, Li₂TiO₃, Li₃PO₄, Li₂MoO₄, Li₂BO₃, LiBO₂, Li₂CO₃, Li₂SiO₃, perovskite-type oxide particles represented by ABO₃ (where A is at least one selected from the group consisting of Ca, Sr, Ba, La, Pr and Y and B is at least one selected from the group consisting of Ni, Ti, V, Cr, Mn, Fe, Co, Mo, Ru, Rh, Pd and Re) and the like.

From the viewpoint of suitably suppressing a side reaction occurring between an electrolytic solution and the coated electrode active material particles, zinc oxide (ZnO), aluminum oxide (Al₂O₃), silicon dioxide (SiO₂) and lithium tetraborate (Li₂B₄O₇) are preferable as the metal oxide particles.

The ceramic particles are preferably glass ceramic particles from the viewpoint of suitably suppressing a side reaction occurring between an electrolytic solution and the coated electrode active material particles.

One kind of these glass ceramic particles may be used singly or two or more kinds thereof may be jointly used.

The glass ceramic particles are preferably a lithium-containing phosphate compound having a rhombohedral system, and the chemical formula thereof is represented by LiₓM″₂P₃O₁₂ (X=1 to 1.7).

Here, M″ is one or more elements selected from Zr, Ti, Fe, Mn, Co, Cr, Ca, Mg, Sr, Y, Sc, Sn, La, Ge, Nb and Al. In addition, some of P may be substituted with Si or B, and some of O may be substituted with F, Cl or the like. For example, Li_{1.15}Ti_{1.85}Al_{0.15}Si_{0.05}P_{2.95}O₁₂, Li_{1.2}Ti_{1.8}Al_{0.1}Ge_{0.1}Si_{0.05}P_{2.95}O₁₂ and the like can be used.

In addition, materials having a different composition may be mixed or composited and the surface may be coated with a glass electrolyte or the like. Alternatively, it is preferable to use glass ceramic particles from which a crystal phase of a lithium-containing phosphate oxide having a NASICON-type structure is precipitated by a heat treatment.

Examples of the glass electrolyte include glass electrolytes described in Japanese Patent Application Publication No. 2019-96478.

Here, the proportion of Li₂O blended in the glass ceramic particles is preferably 8 mass % or less in terms of oxide.

A solid electrolyte containing Li, La, Mg, Ca, Fe, Co, Cr, Mn, Ti, Zr, Sn, Y, Sc, P, Si, O, In, Nb and F, having a LISICON-type crystal structure, a perovskite-type crystal structure, a β-Fe₂(SO₄)₃-type crystal structure and a Li₃In₂(PO₄)₃-type crystal structure and having a Li ion conductivity of 1×10⁻⁵ S/cm or higher at room temperature may be used even when the solid electrolyte does not have a NASICON-type structure.

One kind of the above-described glass ceramic particles may be used or two or more kinds thereof may be jointly used.

The weight proportion of the ceramic particles is preferably 0.5 to 5.0 weight % based on the weight of the coated electrode active material particles.

When the ceramic particles are contained to the above-described extent, it is possible to suitably suppress a side reaction occurring between an electrolytic solution and the coated electrode active material particles.

Next, a method for producing the coated electrode active material particles for a lithium ion battery of the present disclosure will be described.

The method for producing the coated electrode active material particles for a lithium ion battery of the present disclosure has a mixing step of mixing electrode active material particles, a polymer compound, an auxiliary conductive agent, gas adsorption particles and an organic solvent to produce a composition for electrode active material particles and a desolvation step of desolvating the composition for electrode active material particles.

### (Mixing Step)

In the present step, the order of mixing the electrode active material particles, the polymer compound, the auxiliary conductive agent and the gas adsorption particles is not particularly limited, for example, a resin composition composed of the polymer compound, the auxiliary conductive agent and the gas adsorption particles mixed in advance may be further mixed with the electrode active material particles, the electrode active material particles, the polymer compound, the auxiliary conductive agent and the gas adsorption particles may be mixed together at the same time or the polymer compound may be mixed with the electrode active material particles and then the auxiliary conductive agent and the gas adsorption particles may be further mixed therewith.

Preferable materials and the like for the electrode active material particles, the polymer compound, the auxiliary conductive agent and the gas adsorption particles have been already described and will not be thus described again.

The organic solvent is not particularly limited as long as the organic solvent is an organic solvent capable of dissolving the polymer compound, and a well-known organic solvent can be appropriately selected and used.

In the mixing step, it is preferable that, in a state where the electrode active material particles have been put into an all-purpose mixer and stirred at 30 to 500 rpm, a resin solution containing the polymer compound is added dropwise thereto and mixed therewith for one to 90 minutes and the auxiliary conductive agent and the gas adsorption particles are mixed therewith.

The ratio between the electrode active material particles and the resin composition containing the polymer compound, the auxiliary conductive agent and the gas adsorption particles blended in the mixing step is not particularly limited, but the weight ratio between the electrode active material particles and the resin composition is preferably 1:001 to 0.1.

### (Desolvation Step)

In the present step, the organic solvent is desolvated from the mixture after the mixing step.

In the desolvation step, it is preferable that the mixture is heated to 50° C. to 200° C. under stirring, decompressed to 0.007 to 0.04 MPa and then held for 10 to 150 minutes, thereby performing desolvation.

The coated electrode active material particles for a lithium ion battery of the present disclosure can be produced by undergoing the above-described steps.

Next, the applications of the coated electrode active material particles for a lithium ion battery of the present disclosure will be described.

The coated electrode active material particles for a lithium ion battery of the present disclosure can be used at the time of producing electrodes for a lithium ion battery.

For example, an electrode for a lithium ion can be produced by applying a slurry for an electrode active material layer containing the coated electrode active material particles of the present disclosure, an electrolytic solution containing an electrolyte and a solvent and an auxiliary conductive agent or the like as necessary to a current collector and then drying the slurry. Specific examples thereof include a method in which a slurry for an electrode active material layer is applied onto a current collector with a coating device such as a bar coater, the solvent is removed by placing a non-woven fabric on the electrode active material particles to absorb liquid, and the slurry is pressed with a pressing machine as necessary.

In addition, among electrodes for a lithium ion battery for which the coated electrode active material particles for a lithium ion battery of the present disclosure are used, an electrode having the following configuration is an electrode for a lithium ion battery of the present disclosure.

The electrode for a lithium ion battery of the present disclosure is an electrode for a lithium ion battery including an electrode active material layer containing the coated electrode active material particles for a lithium ion battery of the present disclosure and an electrolytic solution containing an electrolyte and a solvent, and the electrode active material layer is made of an unbound body of the coated electrode active material particles for a lithium ion battery.

As the electrolyte that is contained in the electrolytic solution according to the electrode for a lithium ion battery of the present disclosure, electrolytes that are used in well-known electrolytic solutions can be used, and examples thereof include lithium salts of an inorganic anion such as LiFSI, LiPF₆, LiBF₄, LiSbF₆, LiAsF₆, LiClO₄ and LIN (FSO₂)₂ and lithium salts of an organic anion such as LIN (CF₃SO₂)₂, LIN (C₂F₅SO₂)₂ and LiC (CF₃SO₂)₃. Among these, LiFSI and LiN (FSO₂)₂ are preferable from the viewpoint of the battery output and the charge and discharge cycle characteristics.

As the solvent that is contained in the electrolytic solution according to the electrode for a lithium ion battery of the present disclosure, non-aqueous solvents that are used in well-known electrolytic solutions can be used, and it is possible to use, for example, lactone compounds, cyclic or chain carbonates, chain carboxylates, cyclic or chain ethers, phosphates, nitrile compounds, amide compounds, sulfones, sulfolane and mixtures thereof.

Examples of the lactone compounds include lactone compounds of a five-membered ring (γ-butyrolactone, γ-valerolactone or the like) or a six-membered ring (δ-valerolactone or the like) and the like.

Examples of the cyclic carbonates include propylene carbonate, ethylene carbonate (EC), butylene carbonate (BC) and the like.

Examples of the chain carbonates include dimethyl carbonate (DMC), methyl ethyl carbonate (MEC), diethyl carbonate (DEC), methyl-n-propyl carbonate, ethyl-n-propyl carbonate, di-n-propyl carbonate and the like.

Examples of the chain carboxylates include methyl acetate, ethyl acetate, propyl acetate, methyl propionate and the like.

Examples of the cyclic ethers include tetrahydrofuran, tetrahydropyran, 1,3-dioxolane, 1,4-dioxane and the like. Examples of the chain ethers include dimethoxymethane, 1,2-dimethoxyethane and the like.

Examples of the phosphates include trimethyl phosphate, triethyl phosphate, ethyldimethyl phosphate, diethylmethyl phosphate, tripropyl phosphate, tributyl phosphate, tri (trifluoromethyl) phosphate, tri (trichloromethyl) phosphate, tri (trifluoromethyl) phosphate, tri (triperfluoroethyl) phosphate, 2-ethoxy-1,3,2-dioxaphosphorane-2-one, 2-trifluoroethoxy-1,3,2-dioxaphosphorane-2-one, 2-methoxyethoxy-1,3,2-dioxaphosphorane-2-one and the like.

Examples of the nitrile compounds include acetonitrile and the like. Examples of the amide compounds include DMF and the like. Examples of the sulfones include dimethylsulfone, diethylsulfone and the like.

These solvent may be used singly or two or more thereof may be jointly used.

The concentration of the electrolyte in the electrolytic solution is preferably 1.2 to 5.0 mol/L, more preferably 1.5 to 4.5 mol/L, still more preferably 1.8 to 4.0 mol/L and particularly preferably 2.0 to 3.5 mol/L.

In the electrode for a lithium ion battery of the present disclosure, the electrode active material layer is made of an unbound body of the coated electrode active material particles for a lithium ion battery.

Here, the unbound body means that, in the electrode active material layer, the positions of the electrode active material particles are not fixed, the electrode active material particles are not irreversibly fixed to each other and the electrode active material particles and a current collector are not irreversibly fixed to each other.

In a case where the electrode active material layer is an unbound body, since the electrode active material particles are not irreversibly fixed to each other, it is possible to separate the electrode active material particles without causing breakage in the interfaces between the electrode active material particles, and, even in a case where stress is applied to the electrode active material layer, the electrode active material particles migrate, which makes it possible to prevent the breakage of the electrode active material layer, which is preferable.

The electrode active material layer that is an unbound body can be obtained by a method in which an electrode active material layer is produced from a slurry for an electrode active material layer containing the coated electrode active material particles for a lithium ion battery of the present disclosure, an electrolytic solution or the like, but not containing a binder.

In the electrode for a lithium ion battery of the present disclosure, the electrode active material layer may contain a pressure-adhesive resin.

The pressure-adhesive resin means a resin having pressure-sensitive adhesiveness without being solidified even when being dried by volatilizing a solvent component, is a material that is different and differentiated from binders.

In addition, while the coating layers that configure the coated electrode active material particles are fixed to the surfaces of the electrode active material particles, the pressure-sensitive adhesive resin reversibly fixes the surfaces of the electrode active material particles. The pressure-sensitive adhesive resin can be easily separated from the surfaces of the electrode active material particles, but the coating layers cannot be easily separated therefrom. Therefore, the coating layer and the pressure-sensitive adhesive resin are different materials.

Examples of the pressure-sensitive adhesive resin include polymers containing at least one low Tg monomer selected from the group consisting of vinyl acetate, 2-ethylhexyl acrylate, 2-ethylhexyl methacrylate, butyl acrylate and butyl methacrylate as an essential configuration monomer in which the total weight proportion of the low Tg monomers is 45 weight % or more based on the total weight of the configuration monomers.

In the case of using the pressure-sensitive adhesive resin, it is preferable to use 0.01 to 10 weight % of the pressure-sensitive adhesive resin relative to the total weight of the electrode active material particles.

The thickness of the electrode active material layer is preferably 150 to 600 μm and more preferably 200 to 450 μm from the viewpoint of the battery performance.

When the electrode active material layer is formed on a current collector, the electrode active material layer functions as the electrode for a lithium ion battery.

Examples of a material that configures the current collector include metal materials such as copper, aluminum, titanium, stainless steel, nickel and alloys thereof, calcined carbon, conductive polymer materials, conductive glass and the like.

In addition, the current collector may be a resin current collector.

As the conductive polymer resin that configures the resin current collectors, for example, a resin to which a conductive agent is added can be used.

As the conductive agent that configure the conductive polymer material, the same auxiliary conductive agent as the auxiliary conductive agent that is an arbitrary component of the coating layer can be suitably used.

Examples of the resin that configures the conductive polymer material include polyethylene (PE), polypropylene (PP), polymethylpentene (PMP), polycycloolefin (PCO), polyethylene terephthalate (PET), polyethernitrile (PEN), polytetrafluoroethylene (PTFE), styrene butadiene rubber (SBR), polyacrylonitrile (PAN), polymethyl acrylate (PMA), polymethyl methacrylate (PMMA), polyvinylidene fluoride (PVdF), epoxy resins, silicone resins, mixtures thereof and the like.

From the viewpoint of the electrical stability, polyethylene (PE), polypropylene (PP), polymethylpentene (PMP) and polycycloolefin (PCO) are preferable, and polyethylene (PE), polypropylene (PP) and polymethylpentene (PMP) are more preferable.

The resin current collector can be obtained by a well-known method described in Japanese Patent Application Publication No. 2012-150905, WO 2015/005116 and the like.

The shape of the current collector is not particularly limited, and the current collector may be a sheet-like current collector made of the above-described material or a deposited layer made of fine particles composed of the above-described material.

The thickness of the current collector is not particularly limited, but is preferably 50 to 500 μm.

Next, a lithium ion battery of the present disclosure for which the above-described electrode for a lithium ion battery of the present disclosure is used will be described.

The lithium ion battery of the present disclosure includes the above-described electrode for a lithium ion battery of the present disclosure.

The lithium ion battery can be obtained by combining an electrode for a lithium ion battery that is a positive electrode and an electrode for a lithium ion battery that is a negative electrode together, storing the electrodes for a lithium ion battery in a cell container together with a separator, pouring an electrolytic solution into the cell container and sealing the cell container.

At this time, as at least one of the electrode for a lithium ion that is the positive electrode and the electrode for a lithium ion that is the negative electrode, the electrode for a lithium ion battery of the present disclosure is used.

Examples of the separator include well-known separators for a lithium ion battery such as polyethylene or polypropylene porous films, laminate films of a porous polyethylene film and porous polypropylene, non-woven fabrics made of a synthetic fiber (a polyester fiber, an aramid fiber or the like), a glass fiber or the like and the above-described separators containing ceramic fine particles of silica, alumina, titania or the like attached to the surfaces.

Next, an example of the above-described coated electrode active material particles for a lithium ion battery of the present disclosure will be specifically described. Unless particularly otherwise described, “parts” means “parts by weight”.

### Example 33

### [Production of Electrolytic Solution]

LiFSI was dissolved in a solvent mixture of ethylene carbonate (EC) and propylene carbonate (PC) (volume ratio=1:1) in a proportion of 2.0 mol/L to produce an electrolytic solution.

### [Production of Polymer Compound Coating Electrode Active Material]

150 Parts of DMF (N, N-dimethylformamide) was charged into a four-neck flask including a stirrer, a thermometer, a reflux cooling tube, a dropping funnel and a nitrogen gas introduction tube and heated to 75° C. Next, a monomer composition in which 91 parts of acrylic acid, 9 parts of methyl methacrylate and 50 parts of DMF were blended together and an initiator solution containing 0.3 parts of 2,2′-azobis (2,4-dimethylvaleronitrile) and 0.8 parts of 2,2′-azobis (2-methylbutyronitrile) dissolved in 30 parts of DMF were continuously added dropwise with the dropping funnel for two hours under stirring while nitrogen was blown into the four-neck flask to perform radical polymerization. After the end of the dropwise addition, a reaction was continued for three hours at 75° C. Next, the temperature was raised to 80° C., and the reaction was continued for three hours, thereby obtaining a copolymer solution having a resin concentration of 30%. The obtained copolymer solution was moved to a TEFLON (registered trademark) tray and vacuum-dried at 150° C. and 0.01 MPa for three hours to distill DMF away, thereby obtaining a copolymer. This copolymer was roughly crushed with a hammer and then additionally crushed with a mortar, thereby obtaining a powdery polymer compound for coating.

### [Production of Coated Positive Electrode Active Material Particles]

One part of the polymer compound for coating was dissolved in 3 parts of DMF, thereby obtaining a solution of the polymer compound for coating.

89.2 Parts of positive electrode active material particles (LiNi_{0.8}Co_{0.15}Al_{0.05}O₂ powder, volume-average particle diameter: 4 μm) were put into an all-purpose mixer HIGH SPEED MIXER FS25 [manufactured by EarthTechnica Co., Ltd.], and 12 parts of the solution of the polymer compound was added dropwise to the positive electrode active material particles in a state of being stirred at room temperature and 720 rpm for two minutes and further stirred for five minutes.

Next, 3 parts of acetylene black [DENKA BLACK (registered trademark) manufactured by Denka Company Limited.], which was an auxiliary conductive agent, 0.3 parts of activated carbon 4 [manufacturer: UES Co., Ltd., powdered activated carbon KD-PWSSP, average particle diameter: 4 μm], which was gas adsorption particles, and 2 parts of silica (manufactured by Nippon Aerosil Co., Ltd., “Aerosil 200”, average particle diameter: 12 nm), which was ceramic particles, were injected into the solution in a stirred state for two minutes while being divided, and stirring was continued for 30 minutes.

After that, the pressure was reduced to 0.01 MPa while the stirring was maintained, next, the temperature was raised up to 140° C. while the stirring and the degree of pressure reduction were maintained, and the stirring, the degree of pressure reduction and the temperature were maintained for eight hours to distill a volatile component away.

The obtained powder was classified with the sieve having a mesh size of 200 μm, thereby obtaining coated positive electrode active material particles according to Example 33.

### [Production of Coated Negative Electrode Active Material Particles]

One part of the polymer compound for coating was dissolved in 3 parts of DMF, thereby obtaining a solution of the polymer compound for coating.

80 Parts of negative electrode active material particles (hard carbon powder, volume-average particle diameter: 25 μm) were put into the all-purpose mixer HIGH SPEED MIXER FS25 [manufactured by EarthTechnica Co., Ltd.], and 38 parts of the solution of the polymer compound was added dropwise to the negative electrode active material particles in a state of being stirred at room temperature and 720 rpm for two minutes and further stirred for five minutes.

Next, 9.5 parts of acetylene black [DENKA BLACK (registered trademark) manufactured by Denka Company Limited.], which was an auxiliary conductive agent, was injected into the solution in a stirred state for two minutes while being divided, and stirring was continued for 30 minutes.

After that, the pressure was reduced to 0.01 MPa while the stirring was maintained, next, the temperature was raised up to 140° C. while the stirring and the degree of pressure reduction were maintained, and the stirring, the degree of pressure reduction and the temperature were maintained for eight hours to distill a volatile component away.

The obtained powder was classified with the sieve having a mesh size of 200 μm, thereby obtaining coated negative electrode active material particles according to Example 33.

### [Production of Resin Current Collector]

A resin current collector was prepared by the following method.

70 Parts of polypropylene [trade name “SUNALLOMER PL500A” manufactured by SunAllomer Ltd.], 25 parts of carbon nanotubes [trade name: “FloTube 9000” manufactured by Jiangsu Cnano Technology Co., Ltd.] and 5 parts of a dispersant [trade name “UMEX 1001” manufactured by Sanyo Chemical Industries, Ltd.] were melt-kneaded with a twin screw extruder under conditions of 200° C. and 200 rpm, thereby obtaining a resin mixture.

The obtained resin mixture was passed through a T die extrusion film-forming machine and stretch-rolled, thereby obtaining a conductive film for a resin current collector having a film thickness of 100 μm. Next, the obtained conductive film for a resin current collector was cut to be 17.0 cm×17.0 cm, and nickel deposition was performed on a single surface, and terminals for current extraction (5 mm×3 cm) were then connected to the conductive film for a resin current collector, thereby obtaining a resin current collector according to Example 33.

### [Production of Positive Electrode for Lithium Ion Battery]

42 Parts of the electrolytic solution and 4.12 parts of carbon fibers [DONACARBO Milled S-243 manufactured by Osaka Gas Chemicals Co., Ltd.: average fiber length: 500 μm, average fiber diameter: 13 μm, electrical conductivity: 200 mS/cm] and 1.03 parts of highly conductive carbon black [Ketjen black EC300J manufactured by Lion Specialty Chemicals Co., Ltd.] were mixed using a planetary stirring-type kneading machine {Awatori Rentaro [manufactured by THINKY Corporation]} at 2000 rpm for five minutes, subsequently, 30 parts of the electrolytic solution and 206 parts of the coated positive electrode active material particles were added thereto and then further mixed together with the planetary stirring-type kneading machine at 2000 rpm for two minutes, 20 parts of the electrolytic solution was further added thereto and then stirred using the planetary stirring-type kneading machine at 2000 rpm for one minute, furthermore, 2.3 parts of the electrolytic solution was added thereto and then mixed by stirring using the planetary stirring-type kneading machine at 2000 rpm for two minutes, thereby producing a slurry for a positive electrode active material layer. The obtained slurry for a positive electrode active material layer was applied to a single surface of one resin current collector so that the basis weight reached 80 mg/cm² and pressed with a pressure of 1.4 MPa for approximately 10 seconds, thereby forming a positive electrode active material layer and producing a positive electrode for a lithium ion battery (16.2 cm×16.2 cm) according to Example 33 having a thickness of 340 μm.

### [Production of Negative Electrode for Lithium Ion Battery]

42 Parts of the electrolytic solution and 2.06 parts of carbon fibers [DONACARBO Milled S-243 manufactured by Osaka Gas Chemicals Co., Ltd.: average fiber length: 500 μm, average fiber diameter: 13 μm, electrical conductivity: 200 mS/cm] were mixed using a planetary stirring-type kneading machine {Awatori Rentaro [manufactured by THINKY Corporation]} at 2000 rpm for five minutes, subsequently, 30 parts of the electrolytic solution and 206 parts of the coated negative electrode active material particles were added thereto and then further mixed together with the planetary stirring-type kneading machine at 2000 rpm for two minutes, 20 parts of the electrolytic solution was further added thereto and then stirred using the planetary stirring-type kneading machine at 2000 rpm for one minute, furthermore, 2.3 parts of the electrolytic solution was added thereto and then mixed by stirring using the planetary stirring-type kneading machine at 2000 rpm for two minutes, thereby producing a slurry for a negative electrode active material layer. The obtained slurry for a negative electrode active material layer was applied to a single surface of the other resin current collector so that the basis weight reached 80 mg/cm² and pressed with a pressure of 1.4 MPa for approximately 10 seconds, thereby forming a negative electrode active material layer and producing a negative electrode for a lithium ion battery (16.2 cm×16.2 cm) according to Example 33 having a thickness of 340 μm.

### [Production of Lithium Ion Battery]

The obtained positive electrode for a lithium ion battery and negative electrode for a lithium ion battery were combined together through a separator (CELGARD #3501) to produce a laminate cell, thereby producing a lithium ion battery according to Example 33.

### (Example 34) to (Example 42)

Lithium ion batteries according to Examples 34 to 42 were produced in the same manner as in Example 33 except that the kind of the gas adsorption particles used and the weight proportion of each component of the coated electrode active material particles for a lithium ion battery were changed as shown in Table 3.

### Example 43

A lithium ion battery according to Example 43 was produced in the same manner as in Example 33 except that particles produced by the following method were used as coated positive electrode active material particles and coated negative electrode active material particles.

### [Production of Coated Positive Electrode Active Material Particles According to Example 43]

One part of the polymer compound for coating was dissolved in 3 parts of DMF, thereby obtaining a solution of the polymer compound for coating.

89.5 Parts of positive electrode active material particles (LiNi_{0.8}Co_{0.15}Al_{0.05}O₂ powder, volume-average particle diameter: 4 μm) were put into an all-purpose mixer HIGH SPEED MIXER FS25 [manufactured by EarthTechnica Co., Ltd.], and 12 parts of the solution of the polymer compound was added dropwise to the positive electrode active material particles in a state of being stirred at room temperature and 720 rpm for two minutes and further stirred for five minutes.

Next, 3 parts of acetylene black [DENKA BLACK (registered trademark) manufactured by Denka Company Limited.], which was an auxiliary conductive agent, and 2 parts of silica (manufactured by Nippon Aerosil Co., Ltd., “Aerosil 200”, average particle diameter: 12 nm), which was ceramic particles, were injected into the solution in a stirred state for two minutes while being divided, and stirring was continued for 30 minutes.

After that, the pressure was reduced to 0.01 MPa while the stirring was maintained, next, the temperature was raised up to 140° C. while the stirring and the degree of pressure reduction were maintained, and the stirring, the degree of pressure reduction and the temperature were maintained for eight hours to distill a volatile component away.

The obtained powder was classified with the sieve having a mesh size of 200 μm, thereby obtaining coated positive electrode active material particles according to Example 43.

### [Production of Coated Negative Electrode Active Material Particles According to Example 43]

One part of the polymer compound was dissolved in 3 parts of DMF, thereby obtaining a solution of the polymer compound. 77 Parts of negative electrode active material particles (hard carbon powder, volume-average particle diameter: 25 μm) were put into an all-purpose mixer HIGH SPEED MIXER FS25 [manufactured by EarthTechnica Co., Ltd.], and 38 parts of the solution of the polymer compound was added dropwise to the negative electrode active material particles in a state of being stirred at room temperature and 720 rpm for two minutes and further stirred for five minutes.

Next, 9.5 parts of acetylene black [DENKA BLACK (registered trademark) manufactured by Denka Company Limited.], which was an auxiliary conductive agent, and 3 parts of zeolite 10 [Molecular Sieves 5A Powder manufactured by Tomoe Engineering Co., Ltd., volume-average particle diameter: 8 μm], which was gas adsorption particles, were injected into the solution in a stirred state for two minutes while being divided, and stirring was continued for 30 minutes.

After that, the pressure was reduced to 0.01 MPa while the stirring was maintained, next, the temperature was raised up to 140° C. while the stirring and the degree of pressure reduction were maintained, and the stirring, the degree of pressure reduction and the temperature were maintained for eight hours to distill a volatile component away.

The obtained powder was classified with the sieve having a mesh size of 200 μm, thereby obtaining coated negative electrode active material particles according to Example 43.

### Comparative Example 5

A lithium ion battery according to Comparative Example 5 was produced in the same manner as in Example 33 except that, in the [Production Of Coated Positive Electrode Active Material Particles], 89.5 parts of the positive electrode active material particles were used and the gas adsorption particles were not used.

### Comparative Example 6

A lithium ion battery according to Comparative Example 6 was produced in the same manner as in Example 33 except that a positive electrode manufactured by the following method was used as the positive electrode for a lithium ion battery.

[Production of Positive Electrode for Lithium Ion Battery According to Comparative Example 6]

42 Parts of the electrolytic solution and 412 parts of carbon fibers [DONACARBO Milled S-243 manufactured by Osaka Gas Chemicals Co., Ltd.: average fiber length: 500 μm, average fiber diameter: 13 μm, electrical conductivity: 200 mS/cm] and 1.03 parts of highly conductive carbon black [Ketjen black EC300J manufactured by Lion Specialty Chemicals Co., Ltd.] were mixed using a planetary stirring-type kneading machine {Awatori Rentaro [manufactured by THINKY Corporation]} at 2000 rpm for five minutes, subsequently, 30 parts of the electrolytic solution, 189.1 parts of positive electrode active material particles (LiNi_{0.8}Co_{0.15}Al_{0.05}O₂ powder, volume-average particle diameter: 4 μm), 6.3 parts of activated carbon [manufacturer: UES Co., Ltd., powdered activated carbon KD-PWSSP, average particle diameter: 4 μm], which was gas adsorption particles, 6.3 parts of acetylene black [DENKA BLACK (registered trademark) manufactured by Denka Company Limited.], which was an auxiliary conductive agent, and 4.2 parts of silica (manufactured by Nippon Aerosil Co., Ltd., “Aerosil 200”, average particle diameter: 12 nm), which was ceramic particles, were added thereto and then further mixed together with the planetary stirring-type kneading machine at 2000 rpm for two minutes, 20 parts of the electrolytic solution was further added thereto and then stirred using the planetary stirring-type kneading machine at 2000 rpm for one minute, furthermore, 2.3 parts of the electrolytic solution was added thereto and then mixed by stirring using the planetary stirring-type kneading machine at 2000 rpm for two minutes, thereby producing a slurry for a positive electrode active material layer. The obtained slurry for a positive electrode active material layer was applied to a single surface of one resin current collector so that the basis weight reached 80 mg/cm² and pressed with a pressure of 1.4 MPa for approximately 10 seconds, thereby forming a positive electrode active material layer and producing a positive electrode for a lithium ion battery (16.2 cm×16.2 cm) according to Comparative Example 6 having a thickness of 340 μm.

In the positive electrode for a lithium ion battery according to Comparative Example 6, no coating layers were formed on the positive electrode active material particles.

### Comparative Example 7

An attempt was made to produce a lithium ion battery in the same manner as in Example 33 except that the kind of the gas adsorption particles and the weight proportion of each component of the coating layer were changed as shown in Table 3, but it was not possible to form a positive electrode active material layer.

This is considered that, since the average particle diameter of the gas adsorption particles was too large, it was not possible for the positive electrode active material and the auxiliary conductive agent to adhere to each other and a positive electrode active material layer could not be formed.

TABLE 3

| | Composition of coated electrode active material particles | | | | | |
|---|---|---|---|---|---|---|
| | Kind of electrode | | | | | |
| | where coated | Whether or | | | | |
| | electrode active | not coating | | | | Electrode |
| | material particles | layer | Gas adsorption particles | | | active |
| | containing gas | contains gas | | Particle | Content | material |
| | adsorption particles | adsorption | | diameter | (parts by | (parts by |
| | are used | particles | Kind | (μm) | weight) | weight) |
| Example 33 | Positive electrode | Yes | Activated carbon 4 | 4 | 0.3 | 89.2 |
| Example 34 | Positive electrode | Yes | Activated carbon 4 | 4 | 3 | 86.5 |
| Example 35 | Positive electrode | Yes | Activated carbon 4 | 4 | 6 | 83.5 |
| Example 36 | Positive electrode | Yes | Zeolite 8 | 0.045 | 3 | 86.5 |
| Example 37 | Positive electrode | Yes | Zeolite 9 | 20 | 3 | 86.5 |
| Example 38 | Positive electrode | Yes | Zeolite 10 | 8 | 3 | 86.5 |
| Example 39 | Positive electrode | Yes | Silica 5 | 15 | 3 | 86.5 |
| Example 40 | Positive electrode | Yes | Alumina 3 | 12 | 3 | 86.5 |
| Example 41 | Positive electrode | Yes | Activated carbon 4 | 4 | 3 | 86.5 |
| Example 42 | Positive electrode | Yes | Activated carbon 4 | 4 | 3 | 86.5 |
| Example 43 | Negative electrode | Yes | Zeolite 10 | 8 | 3 | 77 |
| Comparative Example 5 | — | No | — | — | — | 89.5 |
| Comparative Example 6 | Positive electrode | No | Activated carbon 4 | 4 | Positive electrode active material layer | |
| | | | | | composed of electrode active material, | |
| | | | | | gas adsorption particles, auxiliary | |
| | | | | | conductive agent and ceramic particles | |
| Comparative Example 7 | Positive electrode | Yes | Zeolite 11 | 35 | 3 | 3 |

| | Composition of coated electrode active material particles | | | | | | |
|---|---|---|---|---|---|---|---|
| | | | | Volume-average | | | |
| | | Auxiliary | | particle diameter | | | |
| | Polymer | conductive | Ceramic | of coated | Evaluation items | | |
| | compound | agent | particles | electrode active | Internal resistance value (Ω) | | |
| | (parts by | (parts by | (parts by | material particles | After | After | After |
| | weight) | weight) | weight) | (μm) | 0 days | 7 days | 14 days |
| Example 33 | 3 | 3 | 2 | 10 | 3.05 | 3.77 | 4.50 |
| Example 34 | 3 | 3 | 2 | 10 | 3.09 | 3.71 | 4.29 |
| Example 35 | 3 | 3 | 2 | 10 | 3.62 | 4.15 | 4.62 |
| Example 36 | 3 | 3 | 2 | 5 | 3.17 | 3.94 | 4.45 |
| Example 37 | 3 | 3 | 2 | 40 | 3.56 | 4.30 | 4.76 |
| Example 38 | 3 | 3 | 2 | 14 | 3.34 | 3.96 | 4.51 |
| Example 39 | 3 | 3 | 2 | 23 | 3.30 | 4.13 | 4.86 |
| Example 40 | 3 | 3 | 2 | 20 | 3.25 | 3.96 | 4.70 |
| Example 41 | 3 | 3 | 2 | 10 | 2.97 | 3.73 | 4.59 |
| Example 42 | 3 | 3 | 2 | 10 | 2.88 | 4.08 | 4.93 |
| Example 43 | 9.5 | 9.5 | 2 | 20 | 3.12 | 4.28 | 4.71 |
| Comparative Example 5 | 3 | 3 | 2 | 10 | 3.21 | 5.51 | 8.39 |
| Comparative Example 6 | Positive electrode active material layer | | | | 3.13 | 5.06 | 6.38 |
| | composed of electrode active material, | | | | | | |
| | gas adsorption particles, auxiliary | | | | | | |
| | conductive agent and ceramic particles | | | | | | |
| Comparative Example 7 | 3 | 3 | 2 | 50 | — | — | — |

The kinds of gas adsorption particles in Table 3 are as described below.
Activated carbon 4: Product name “powdered activated carbon KD-PWSSP”, average particle diameter: 4 μm, manufacturer: UES Co., Ltd.
Zeolite 8: Product name “Zeoal 4A”, average particle diameter: 0.045 μm, manufacturer: Nakamura Choukou Co., Ltd.
Zeolite 9: Product name “Molecular Sieves 5A Pellet”, average particle diameter: 20 μm, manufacturer: Tomoe Engineering Co., Ltd.
Zeolite 10: Product name “Molecular Sieves 5A Powder”, average particle diameter: 8 μm, manufacturer: Tomoe Engineering Co., Ltd.
Zeolite 11: Product name “Molecular Sieves 5A Pellet”, average particle diameter: 40 μm, manufacturer: Tomoe Engineering Co., Ltd.
Silica 5: Product name “silica powder”, average particle diameter: 9 μm, manufacturer: Maruto Co., Ltd.
Alumina 3: Product name “activated alumina AA-101”, average particle diameter: 12 μm, manufacturer: Nippon Light Metal Co., Ltd.
“Zeolite 9”, “Zeolite 11” and “Silica 5” were crushed with a mortar, and the average particle diameters were arranged with a sieve.

### <Measurement of Internal Resistance Value>

The lithium ion battery obtained in each of the examples and the comparative examples was charged up to a voltage of 4.2 V at a constant current of 0.05 C at 25° C. using a charge and discharge measuring instrument “BATTERY ANALYZER 1470 TYPE” [manufactured by TOYO Corporation] and then charged until the current value reached 0.01 C in a constant voltage state of 4.2 V. After 10 seconds of a pause, the lithium ion battery was discharged to a voltage of 2.5 V at a constant current of 0.01 C and charged up to a voltage of 4.2 V at a constant current of 0.05C. Next, the charged lithium ion battery was stored under an environment of 60° C.

The internal resistance values at a frequency of 1000 Hz after zero days (immediately after full charge), after seven days of storage and after 14 days of storage were measured using an impedance measuring instrument (manufactured by Hioki E. E. Corporation, CHEMICAL IMPEDANCE ANALYZER IM3590). The results are shown in Table 3.

As shown in Table 3, it was clarified that, in the lithium ion battery of each example, the internal resistance value (Ω) was less likely to increase.

This is considered to be because the coating layers of the coated electrode active material particles of each example contained the gas adsorption particles and was thus capable of adsorbing gases that were generated in association with the charge and discharge of the lithium ion battery and capable of preventing the occurrence of the gas-induced swelling of the battery that was caused by the gases.

In the present specification, the following technical ideas that are described in the basic application of the present international application are described.

(1-1) A battery pack having two or more cells provided with a lamination unit composed of a single set of a positive electrode resin current collector, a positive electrode active material layer, a separator, a negative electrode active material layer and a negative electrode resin current collector sequentially laminated together, the two or more cells being sealed in an exterior body,
in which filler materials are provided in gaps between the cells and/or gaps between the cell and the exterior body.
(1-2) The battery pack according to (1-1), in which a tensile shear strength between the filler material and a PET plate is 0.05 N/mm² or higher.
(1-3) The battery pack according to (1-1) or (1-2), in which the filler material contains gas adsorption particles.
(1-4) The battery pack according to (1-3), in which the gas adsorption particles are one or more selected from the group consisting of activated carbon, zeolite, silica and alumina.
(1-5) The battery pack according to (1-3) or (1-4), in which a weight proportion of the gas adsorption particles is 30 to 50 weight % based on a weight of the filler material.
(1-6) The battery pack according to any one of (1-3) to (1-5), in which a volume-average particle diameter of the gas adsorption particles is 0.04 to 50 μm.
(2-1) A resin current collector for a lithium ion battery composed of a resin composition containing a polyolefin resin, a conductive filler and gas adsorption particles,
in which a weight proportion of the gas adsorption particles is 5 to 20 weight % based on a weight of the resin current collector for a lithium ion battery, and
the gas adsorption particles are one or more selected from the group consisting of activated carbon, zeolite, silica and alumina.
(2-2) The resin current collector for a lithium ion battery according to (2-1), in which a volume-average particle diameter of the gas adsorption particles is 0.04 to 20 μm.
(2-3) The resin current collector for a lithium ion battery according to (2-1) or (2-2), in which a weight proportion of the conductive filler is 15 to 20 weight % based on a weight of the resin current collector for a lithium ion battery.
(2-4) The resin current collector for a lithium ion battery according to any one of (2-1) to (2-3), in which a film thickness of the resin current collector for a lithium ion battery is 30 to 60 μm.
(2-5) A lithium ion battery including the resin current collector for a lithium ion battery according to any one of (2-1) to (2-4).
(3-1) A coated electrode active material particle for a lithium ion battery in which at least a part of a surface of the electrode active material particle is coated with a coating layer,
in which the coating layer contains gas adsorption particles, a polymer compound and an auxiliary conductive agent, and
a volume-average particle diameter of the gas adsorption particles is 0.04 to 20 μm.
(3-2) The coated electrode active material particle for a lithium ion battery according to (3-1), in which the gas adsorption particles are one or more selected from the group consisting of activated carbon, zeolite, silica and alumina.
(3-3) The coated electrode active material particle for a lithium ion battery according to (3-1) or (3-2), in which a weight proportion of the gas adsorption particles is 0.3 to 6 weight % based on a weight of the coated electrode active material particle.
(3-4) The coated electrode active material particle for a lithium ion battery according to any one of (3-1) to (3-3), in which a volume-average particle diameter of the coated electrode active material particles for a lithium ion battery is 5 to 40 μm.
(3-5) An electrode for a lithium ion battery including an electrode active material layer containing the coated electrode active material particles for a lithium ion battery according to any one of (3-1) to (3-4) and an electrolytic solution containing an electrolyte and a solvent,
in which the electrode active material layer is made of an unbound body of the coated electrode active material particles for a lithium ion battery.
(3-6) A lithium ion battery including the electrode for a lithium ion battery according to (3-5).

1 (3-7) A method for producing the coated electrode active material particles for a lithium ion battery according to any one of (3-1) to (3-4), having a mixing step of mixing electrode active material particles, a polymer compound, an auxiliary conductive agent, gas adsorption particles and an organic solvent to produce a composition for an electrode active material particle and
a desolvation step of desolvating the composition for an electrode active material particle.

### INDUSTRIAL APPLICABILITY

The battery pack of the present invention is capable of preventing an increase in the internal resistance value even when external vibrations are applied during the production, transportation or use of the battery and thus can be made into a battery pack that can be used under an environment where vibrations are applied.

### REFERENCE SIGNS LIST

1, 2, 3, 4 Battery pack
11 Positive electrode resin current collector
13 Positive electrode active material layer
21 Negative electrode resin current collector
23 Negative electrode active material layer
30 Separator
40 Frame member
40a Positive electrode frame member
40b Negative electrode frame member
60, 60a, 60b Filler material
100, 101 Cell
111,121 High-voltage tab
120 Exterior body

1. A battery pack having two or more cells provided with a lamination unit composed of a single set of a positive electrode resin current collector, a positive electrode active material layer, a separator, a negative electrode active material layer and a negative electrode resin current collector sequentially laminated together, the two or more cells being sealed in an exterior body,
wherein filler materials are provided in gaps between the cells and/or gaps between the cell and the exterior body.

2. The battery pack according to claim 1, wherein
a tensile shear strength between the filler material and a PET plate is 0.05 N/mm² or higher.

3. The battery pack according to claim 1, wherein
the filler material contains gas adsorption particles.

4. The battery pack according to claim 3, wherein
a weight proportion of the gas adsorption particles is 30 to 50 weight % based on a weight of the filler material.

5. The battery pack according to claim 3, wherein
a volume-average particle diameter of the gas adsorption particles is 0.04 to 50 μm.

6. The battery pack according to claim 1, wherein
the positive electrode resin current collector and/or the negative electrode resin current collector is a resin current collector composed of a resin composition containing a polyolefin resin, a conductive filler and gas adsorption particles, and
a weight proportion of the gas adsorption particles is 5 to 20 weight % based on a weight of the resin current collector.

7. The battery pack according to claim 6, wherein
a volume-average particle diameter of the gas adsorption particles is 0.04 to 20 μm.

8. The battery pack according to claim 6, wherein
a weight proportion of the conductive filler is 15 to 20 weight % based on a weight of the resin current collector.

9. The battery pack according to claim 6, wherein
a film thickness of the resin current collector is 30 to 60 μm.

10. The battery pack according to claim 1, wherein
the positive electrode active material layer and/or the negative electrode active material layer is an electrode active material layer containing a coated electrode active material particle for a lithium ion battery in which at least a part of a surface of the electrode active material particle is coated with a coating layer,
the coating layer contains gas adsorption particles, a polymer compound and an auxiliary conductive agent, and
a volume-average particle diameter of the gas adsorption particles is 0.04 to 20 μm.

11. The battery pack according to claim 10, wherein
a weight proportion of the gas adsorption particles is 0.3 to 6 weight % based on a weight of the coated electrode active material particle.

12. The battery pack according to claim 10, wherein
a volume-average particle diameter of the coated electrode active material particles for a lithium ion battery is 5 to 40 μm.

13. The battery pack according to claim 10, wherein
the electrode active material layer contains the coated electrode active material particles for a lithium ion battery and an electrolytic solution containing an electrolyte and a solvent and is made of an unbound body of the coated electrode active material particles for a lithium ion battery.

14. The battery pack according to claim 3, wherein
the gas adsorption particles are one or more selected from the group consisting of activated carbon, zeolite, silica and alumina.
